(19) United States
(12) Patent Application Publication
(10) Pub. No.: US 2026/0111503 A1
(43) Pub. Date: Apr. 23, 2026

(54) SYSTEM AND METHOD FOR MACHINE LEARNING DRIVEN ELECTRONIC INTERFACE NAVIGATION

(71) Applicant: ROYAL BANK OF CANADA, Toronto (CA)

(72) Inventors: Ehsan AMJADIAN, Toronto (CA); Iustina-Miruna VINTILA, Bucharest (RO); Edison U. ORTIZ, Orlando, FL (US); Dharitri RATHOD, Orlando, FL (US); Shawn DENG, Toronto (CA); Kyra GRANT, Toronto (CA); Emma HOLLAND, Toronto (CA); Shahed SHIRAZI, Toronto (CA)

(21) Appl. No.: 19/218,209

(22) Filed: May 23, 2025

Related U.S. Application Data
(63) Continuation-in-part of application No. 18/385,784, filed on Oct. 31, 2023.
(63) Continuation-in-part of application No. 18/385,887, filed on Oct. 31, 2023.
(60) Provisional application No. 63/420,912, filed on Oct. 31, 2022.
(60) Provisional application No. 63/421,144, filed on Oct. 31, 2022.
(60) Provisional application No. 63/651,327, filed on May 23, 2024.

(51) Int. Cl. G06F 16/954; G06N 20/00

(52) U.S. Cl. CPC G06F 16/954; G06N 20/00

(57) ABSTRACT

A user device operating a browser extension adapted for machine-learning based field value injection into a browser session is described herein, the machine-learning based field value injection coordinated between local edge computing storage and a centralized federated machine learning model computing backend. A plurality of separate local machine learning models are configured for interoperation with a centralized federated machine learning model computing backend to distribute computational activities and cost associated with updating machine learning models. An autofill local machine learning model is used to autofill certain fields based on a model locally trained using interaction data tracked by the browser extension.

### CROSS-REFERENCE

This application is a non-provisional of, and claims all priority from, U.S. Application No. 63/651327, dated 23 May 2024, entitled SYSTEM AND METHOD FOR MACHINE LEARNING DRIVEN ELECTRONIC INTERFACE NAVIGATION. This application is incorporated herein by reference in its entirety. This application is also a continuation in part of U.S. application Ser. No. 18/385784, dated 31 Oct. 2023, entitled SYSTEM AND METHOD FOR AUTOFILL OF WEBPAGE FIELDS, which claims priority to U.S. Application No. 63/420912, dated 31 Oct. 2022, also entitled SYSTEM AND METHOD FOR AUTOFILL OF WEBPAGE FIELDS. This application is incorporated herein by reference in its entirety. This application is also a continuation in part of U.S. application Ser. No. 18/385887, dated 31 Oct. 2023, entitled SYSTEM AND METHOD FOR MACHINE LEARNING ARCHITECTURE FOR ELECTRONIC FIELD AUTOFILL, which claims priority to U.S. Application No. 63/421144, dated 31 Oct. 2022, also entitled SYSTEM AND METHOD FOR MACHINE LEARNING ARCHITECTURE FOR ELECTRONIC FIELD AUTOFILL. This application is incorporated herein by reference in its entirety.

### FIELD

Embodiments of the present disclosure relate to electronic interface navigation using machine learning, and more specifically, electronic interface navigation using machine learning in a federated learning architecture, where a hybrid computing interface is provided in the form of a browser extension that operates as an edge computing node in conjunction with a federated learning architecture, and is adapted for page classification to improve operational efficiency.

### INTRODUCTION

A challenge with electronic field autofill is that there is significant variability in how web pages or web objects are presented from different sources, such as different eCommerce vendors, different platforms, different financial payment processing systems, all of which may utilize different coding approaches and architectures.

It can be difficult to provide a scalable and robust solution for autofill of fields in a website, that operates sufficiently and effectively in different types of contextual situations encountered in practical real-world implementation.

In addition, when machine learning is used to automate electronic transactions, one or more machine learning models need to be trained using training data. In standard machine learning model training, training data is typically collected and stored in one or a few central data storage server(s). For example, in order to train a machine learning model to detect one or more fraudulent transactions, electronic records representing transactions from a number of institutions across many different users are gathered and processed as training data. However, such collection and central storage of electronic records pertaining to personal financial data may raise data privacy and security concerns, or may be restricted due to local regulations and laws.

Because of these reasons, the computing systems are segregated from one another and the available communication pathways are limited or non-existent to preserve privacy. These technical limitations pose a significant technical problem for coordinated machine learning.

### SUMMARY

Electronic field autofill is a useful technical feature to implement in web page/web flow orchestration, as among others, it reduces certain frictions faced by users visiting web pages or encountering various web objects on web interfaces, such as the need to enter redundant information into web object input elements, including for example input boxes, forms, radio button lists, among others.

Electronic field autofill is a website feature which can be used at different levels of technical integration. For example, there can be autofill that can be used for factual data insertion, such as names, addresses, credit card numbers, etc. However, autofill can be utilized for more sophisticated examples where the autofill insertion not only covers information that are directly obtainable from data storage fields corresponding to a user's profile, but also can include a more intelligent autofill mechanism that interoperates with a computing backend to autofill or auto insert (or in some embodiments, provide a set of autofill options) that are based on a corpus of tracked data representative of lifestyle, beyond shopping. Accordingly, electronic field autofill can be implemented to make a customer's shopping journey on eCommerce website more pleasant and efficient, where a customer must traverse through a number of different web pages (or simply “pages” throughout the disclosure) relating to different selection, payment, and/or checkout flows, making the shopping experience faster, smoother and more robust relative to previous approaches (e.g., manual entry of user data).

As described herein, the autofill can be coupled with the machine learning backend architecture that includes both a combination of machine learning components operating at two different computing devices, a first set of machine learning operations being conducted at the edge (e.g., using data collected and stored locally when a user is using an extension and not made available to any other users), as well as a backend confidential federated learning architecture, which can interact with the edge deployment for coordinating updates between a global and a local model.

However, in practical computer implementation, electronic field autofill yields non-trivial computational and technical challenges. Specifically, in relation to certain types of dynamically rendered and loaded web elements, such as the use of iframes, the dynamically rendered and loaded web elements include elements that are dynamically assigned random and/or different identifiers on load. For this reason, conventional approaches to autofill are unable to operate because they cannot readily identify the element to conduct operations against (e.g., selectors and identifier data values may be dynamically assigned). The implementation of these dynamically rendered and loaded web elements such as iframes can be as part of an intentional design for cybersecurity reasons, among others, nevertheless, such dynamic web elements yield technical challenges in respect of conducting autofill operations.

An improved approach is proposed which utilizes a watcher process to monitor changes in a DOM structure or other indicators of a website having a plurality of web pages, in order to conduct one or more rounds of autofill of one or more input fields on the website.

In operation, when a web server delivers one or more web pages to a user, the operation of an autofill engine within a system described herein can generate and automatically fill, without the user having to manually entering any information, predetermined (e.g., as generated by a machine learning engine) values for different input fields in different interactive display elements on a user interface through injecting values into the input fields by an injection engine of the system. The injected values may be implemented as part of content through content scripts, while background processes (e.g., background scripts) interoperate in accordance with proposed approaches herein, all of which are coordinated through a browser controller that can initiate a page classifier module, a field classifier module, and a watcher process.

This solves a technical problem that arises in respect of real-world practical applications, where as a user visits different websites, common user data and site data may be automatically carried from one session with a first web page or website to another session with a different web page or web site. An objective may be to provide a harmonized experience for the user where the system is able to automatically engage in data message flows to securely synchronize backend operation, providing a specific technical improvement over alternate approaches which are limited by the “walled garden” technical limitations imposed by the technical ecosystems in which the applications or web servers operate within.

In accordance with one aspect, there is provided a system for autofill of one or more input fields on a web page, the system may include: a processor; a memory device storing one or more local machine learning models; a non-transitory computer-readable media storing instructions that when executed by the processor, cause the system to: obtain a first data set representative of user data associated with a user device used to access one or more web pages from a web server; obtain a second data set representative of site data from data communication messages between the user device and the web server; determine, using a page classifier module from the one or more local machine learning models, if a current web page from the one or more web pages includes at least one input field for autofill; when the current web page is determined to include at least one input field for autofill: use a field classifier module from the one or more local machine learning models to identify one or more input fields for autofill from the at least one input field; generate, based on one or both of the user data and site data, one or more values for the one or more input fields; and perform an autofill of the one or more input fields with the one or more values.

In some embodiments, the one or more local machine learning (ML) models are trained using user data stored on the memory device.

In some embodiments, the instructions, when executed by the processor, cause the system to: update model weights or parameters by training at least one ML model from the one or more local machine learning models using the user data; transmit the updated model weights or parameters to a central aggregator; receive a global model update from the central aggregator; and update the at least one ML model based on the global model update.

In some embodiments, the global model update comprises a global ML model for the at least one ML model.

In some embodiments, the global model update comprises a global model parameters or weights for a global ML model for the at least one ML model.

In some embodiments, the instructions, when executed by the processor, cause the system to: initiate a watcher process to periodically or continuously monitor changes in the current web page; perform an initial autofill of the one or more input fields in the current web page; and upon detecting a change on the current web page, perform a second autofill of the one or more input fields in the current web page.

In some embodiments, performing an autofill of the one or more input fields with the one or more values comprises: simulating a user-agent; and injecting, into an instruction set for loading user interface (UI) elements on a user interface for the current web page, a value from the one or more values, the value generated based on at least one data set from the user data.

In some embodiments, simulating the user-agent comprises simulating a sequence of Hypertext Markup Language (HTML) events configured to simulate actions of the user-agent.

In some embodiments, the sequence of HTML events is pre-determined based on a type of input field from the one or more input fields.

In some embodiments, the value comprises part of payment or delivery information.

In some embodiments, the instructions, when executed by the processor, cause the system to: initiate a listener when a dormant script associated with the current web page indicates that an iframe is loaded as part of the current web page; and upon detecting, by the listener, that the iframe loaded is related to a checkout or payment process, perform autofill of one or more payment fields in the iframe loaded.

In some embodiments, the watcher process is configured to monitor changes in a Document Object Model (DOM) associated with the current web page.

In some embodiments, the watcher process is configured to monitor changes in one or more selectors in the site data.

In some embodiments, the one or more one or more values used for autofill for the one or more input fields are generated using a machine learning module.

In accordance with another aspect, there is provided a computer-implemented method for autofill of one or more input fields on a web page, the method may include: obtaining a first data set representative of user data associated with a user device used to access one or more web pages from a web server; obtaining a second data set representative of site data from data communication messages between the user device and the web server; determining, using a page classifier module, if a current web page from the one or more web pages includes at least one input field for autofill; when the current web page is determined to include at least one input field for autofill: using a field classifier module to identify one or more input fields for autofill from the at least one input field; generating, based on one or both of the user data and site data, one or more values for the one or more input fields; and performing an autofill of the one or more input fields with the one or more values.

In some embodiments, the method includes initiating a watcher process to periodically or continuously monitor changes in the current web page; performing an initial autofill of the one or more input fields in the current web page; and upon detecting a change on the current web page, performing a second autofill of the one or more input fields in the current web page.

In some embodiments, performing an autofill of the one or more input fields with the one or more values comprises: simulating a user-agent; and injecting, into an instruction set for loading user interface (UI) elements on a user interface for the current web page, a value from the one or more values, the value generated based on at least one data set from the user data.

In some embodiments, simulating the user-agent comprises simulating a sequence of Hypertext Markup Language (HTML) events configured to simulate actions of the user-agent.

In some embodiments, the sequence of HTML events is pre-determined based on a type of input field from the one or more input fields.

In some embodiments, the method includes initiating a listener when a dormant script associated with the current web page indicates that an iframe is loaded as part of the current web page; and upon detecting, by the listener, that the iframe loaded is related to a checkout or payment process, performing autofill of one or more payment fields in the iframe loaded.

In some embodiments, the watcher process is configured to monitor changes in a Document Object Model (DOM) associated with the current web page.

In some embodiments, the watcher process is configured to monitor changes in one or more selectors in the site data.

In some embodiments, the one or more one or more values used for autofill for the one or more input fields are generated using a machine learning module.

In accordance with yet another aspect, there is provided a non-transitory computer readable medium storing machine interpretable instructions, when executed by a processor, cause the processor to perform: obtaining a first data set representative of user data associated with a user device used to access one or more web pages from a web server; obtaining a second data set representative of site data from data communication messages between the user device and the web server; determining, using a page classifier module, if a current web page from the one or more web pages includes at least one input field for autofill; when the current web page is determined to include at least one input field for autofill: using a field classifier module to identify one or more input fields for autofill from the at least one input field; generating, based on one or both of the user data and site data, one or more values for the one or more input fields; and performing an autofill of the one or more input fields with the one or more values.

In accordance with one aspect, there is provided a system for autofill one or more input fields on a web page, the system including: a processor operating in conjunction with computer memory and non-transitory computer readable media operating as a data storage, the processor configured to: obtain one or more data sets representative of user data and site data from data communication messages between a user device and a website having one or more web pages; perform an initial autofill of one or more input fields in a web page from the one or more web pages; initiate a watcher process to periodically or continuously monitor changes in the one or more web pages; and upon detecting an iframe trigger on a web page, conduct a second autofill of one or more input fields in the web page.

In some embodiments, an autofill of a field in the web page comprises injecting, into an instruction set for loading user interface (UI) elements on a user interface for the web page, a value based on at least one data item from the user data.

In some embodiments, the value may be part of payment card information.

In some embodiments, the value may be one of: a name, a credit card number, an expiry date, a billing address, and a telephone number.

In some embodiments, the value may be part of delivery information.

In some embodiments, the value may be one of: a name, a shipping address, a telephone number, and an e-mail address.

In some embodiments, the watcher process is configured to monitor changes in the Document Object Model (DOM).

In some embodiments, the watcher process is configured to monitor changes in one or more selectors in the site data.

In some embodiments, the second autofill is only conducted when the initial autofill fails.

In some embodiments, the second autofill is conducted with an interval.

In some embodiments, one or more one or more values used for autofill for the one or more input fields are generated based on output from a machine learning algorithm.

In accordance with another aspect, there is provided a computer-implemented method for autofill one or more input fields on a web page, the method including the steps of: obtaining one or more data sets representative of user data and site data from data communication messages between a user device and a website having one or more web pages; performing an initial autofill of one or more input fields in a web page from the one or more web pages; initiating a watcher process to periodically or continuously monitor changes in the one or more web pages; and upon detecting an iframe trigger on a web page, conducting a second autofill of one or more input fields in the web page.

In some embodiments, an autofill of a field in the web page comprises injecting, into an instruction set for loading user interface (UI) elements on a user interface for the web page, a value based on at least one data item from the user data.

In some embodiments, the value may be part of payment card information.

In some embodiments, the value may be one of: a name, a credit card number, an expiry date, a billing address, and a telephone number.

In some embodiments, the value may be part of delivery information.

In some embodiments, the value may be part of a payment information.

In some embodiments, the value may be one of: a name, a credit card number, an expiry date, a billing address, and a telephone number.

In some embodiments, the value may be part of delivery information.

In some embodiments, the value may be one of: a name, a shipping address, a telephone number, and an e-mail address.

In some embodiments, the watcher process is configured to monitor changes in the Document Object Model (DOM).

In some embodiments, the watcher process is configured to monitor changes in one or more selectors in the site data.

In some embodiments, the second autofill is only conducted when the initial autofill fails.

In some embodiments, the second autofill is conducted with an interval.

In some embodiments, one or more one or more values used for autofill for the one or more input fields are generated based on output from a machine learning algorithm.

In accordance with yet another aspect, there is provided a non-transitory computer readable medium storing machine interpretable instructions, when executed by a processor, cause the processor to perform any of the above methods.

### BRIEF DESCRIPTION OF THE DRAWINGS

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a block schematic diagram of an example system for performing autofill of one or more input fields in a web page of a website, according to some embodiments.

FIG. 2 is a schematic diagram showing an overlap between user data and site data on a web page, according to some embodiments.

FIG. 3 is an example web page including an iframe, according to some embodiments.

FIG. 4 is an example process performed by the system in FIG. 1 for performing autofill of one or more input fields in a web page of a website, according to some embodiments.

FIG. 5 is an example computer device that may be used to implement the system in FIG. 1 for performing autofill of one or more input fields in a web page of a website, according to some embodiments.

FIG. 6 is another example process performed by the system in FIG. 1 for performing autofill of one or more input fields in a web page, according to some embodiments.

FIG. 7 shows an example web browser with multiple web pages in communication with the system in FIG. 1, in accordance with some example embodiments.

FIG. 8 shows an example web browser with a web page being autofilled by the system in FIG. 1, in accordance with some example embodiments.

FIG. 9 shows an example of screen capture of a user interface displaying user data that can be validated by a user, in accordance with some example embodiments.

FIG. 10 shows a schematic diagram illustrating a simplified concept of federated learning (FL) architecture and local model deployment, in accordance with some example embodiments.

FIG. 11 shows a schematic diagram showing an example FL architecture with browser extension, in accordance with some example embodiments.

FIG. 12 shows an example embodiment of a browser with a browser extension having a number of local machine learning models deployed, in accordance with some example embodiments.

FIGS. 13A and 13B show an example schematic diagram illustrating a browser process, in accordance with some example embodiments.

FIG. 14 illustrates an example process of automating an user's browsing and shopping journey using FI-trained local machine learning models, in accordance with some example embodiments.

FIGS. 15 and 16 illustrate an example process of training and updating FI-trained local machine learning models, in accordance with some example embodiments.

FIGS. 17A and 17B illustrate an example process for building a user profile from local data and utilizing local ML models to generate customized inventory recommendations to a user, in accordance with some example embodiments.

FIGS. 18A, 18B and 18C shows three parts of an example schematic diagram illustrating an automated signal and data collection process, in accordance with one example embodiment.

FIG. 19 shows example signal processing of various user actions and triggers detected on a web page.

### DETAILED DESCRIPTION

As disclosed herein, an improved system is provided to enhance user experience (and user values) through performing autofill of one or more input fields in a web page of a website, which may involve automatically filling fields associated with one or more user interface (UI) elements with one or more values; the autofill of values for the UI elements may be rendered during particular set points within a user's browsing and/or shopping experience on a particular website, such as, for example, during a payment flow.

A user's browsing session, from a computational perspective, may include a series of state transitions between different user interface interaction points. The user interface rendered on a user's browser may include a number of UI elements, which may be filled or modified by computational elements of the system through injection (and where appropriate, re-injection) into the instruction set or code for rendering said user interface.

The autofill mechanism of the proposed approach is enhanced to improve the efficiency of the underlying autofill mechanism by incorporating machine learning steps to assist in determining page types and field types for code injection. In particular, a two-stage trained machine learning model approach can be used including a page classifier and a subsequent field classifier.

By using a two-stage trained machine learning model, the architecture is able to attain improved computational efficiency because the page classifier, which is configured to detect whether a particular page is a checkout page as opposed to an informational page operates first, and then the more computationally heavy field classifier (that is used for controlling injection) is run only if the page classifier classifies the page as a page for injection to be conducted.

This is particularly important where the computational costs of operating the autofill/injection mechanism are higher due to increased complexity in operation. As described herein, more sophisticated models and model architectures are also being proposed for usage that use a combination of edge computing and federated computing with a centralized global backend. These more sophisticated models and model architectures are used for more “intelligent” autofill beyond directly filling in factual information that can be obtained from profile fields, and rather, are used to generatively fill in information based on the user's profile, tracked interactions, representative of the user's journey.

As an example of a more sophisticated autofill computational process, there can be a free form field associated with special requests as part of a gift checkout purchase. The page classifier in this example classifies the page as a checkout page, and the field classifier model is invoked. The field classifier model can be used to classify each field, and assist with identifying a proposed string or value to insert into each field. For some fields, such as name, mailing address, billing address, etc., these fields can be inserted with data directly from the user's profile. However, as noted, there can be other fields such as “special requests”, “delivery instructions”, “buy now pay later”, among others, and these types of fields can be more challenging for the field classifier to insert. By providing more information, including more “freeform” type fields, the autofill can be even more useful for the customer as it can provide companion-based insights based on the user's profile for autofill.

In this example, a combination of edge computing and federated computing model architectures and corresponding trained models as well as local data are utilized to generate autofill inputs that can include data inputs that are customized for the user. For example, the special requests can include an indication that a gift receipt needs to be included because this is a gift for another person, or the application of a specific discount automatically identified based on the user's estimated eligibility. Similarly, for delivery instructions, based on an estimation from the machine learning model, there can be specific accessibility requests tailored for the user, etc. Compared to a straightforward look up table-based autofill, these types of freeform requests tailored specifically for the user's journey require the usage of more sophisticated and computationally complex models.

In a further variation, during a checkout process, the website can also include one or more fields requiring a hyper-level of personalization and personal information, and these fields can either be visible, marked, or hidden fields that are specifically designed for automatic interaction with the autofill extension. These hyper-personalization fields can be associated with a specific type of tag or flag by the website code, in some embodiments, for example, in the field input control box type itself. Examples of fields requiring a hyper-level of personalization and personal information can include fields that are used to establish a hyper-personalized loan in advance to support a very customized and tailored in-line determination for whether the user qualifies for a type of “buy now pay later”type loan (or a mortgage package).

The amount of information required for establishing a loan can be voluminous and cumbersome to enter, and the autofill utilizes the machine learning backend to ease this burden by providing an automatic technical solution that can operate through the extension as a “behind the scenes” daemon process that is invoked by the field classifier once a field is classified as a field requiring hyper-personalization inputs. Upon a field is classified as a field requiring hyper-personalization inputs, the daemon process can operate on the backend to generate proposed generative autofill inputs using a combination of available edge data and federated machine learning architectures such that by the time the user encounters the field through normal browsing of the website, a generative/predictive entry can be presented by the extension through rendering, for example, of suggested text that can be automatically inserted.

In another variation, the extension can also interoperate with hidden fields behind the scenes on the website to transmit an encrypted package of proofs that a user is qualified based on the field classification and one or more generative/predictive entries to automatically “make a case” that a user is qualified for a particular financial product or mortgage, and the website, without requiring any input, modifies the customer's journey, for example, to inject pages or webpage controls showing a “buy now pay later” or hyper-personalized loan availability if the extension is able to provide a sufficiently persuasive customized input based on the user's information and the underlying machine learning model architecture outputs.

As a default or if the user is not qualified, the webpage simply does not provide the option for “buy now pay later” or hyper-personalized loan availability, for example. Accordingly, in this example, the extension can act as an additional assistant mechanism to automatically and behind the scenes help negotiate for specific products such that a specially configured website can automatically present a mortgage package or product in advance given an automated negotiation between the page and the extension, as well as the extension's locally stored knowledge presentations of their preferences.

Similarly, instead of providing a hyper-personalized loan product, another potential use case is for the presentment of personalized in-line offers and coupons, and the website owner may also include a marketing campaign targeting specific types of users or demographics, such as “back to school” users having a specific qualification, or those users having a history of purchasing a large number of a particular product across multiple websites or having a specific type of research or purchasing journey. Because of the segregation between merchants and a potential lack of cross-site cookies and tracking, it can be difficult for the website to gauge eligibility for the campaign. In this variant embodiment, for example, the website can include a hidden campaign field, and the extension can be configured to generate the encrypted package of proofs that a user is qualified based on the field classification and one or more generative/predictive entries to automatically “make a case” that a user is indeed qualified, and the promotion should extend to this user.

In a further variant embodiment, a website can include a dynamic range of potential pre-authorized promotions that can be triggered based on this response. For example, if the user is, as identified through the user's browsing history or other tracked interactions. To preserve the user's privacy and actual browsing history or tracked interactions, only an embedding-based trained model is stored locally (which may or may not be stored along with the actual browsing history or tracked interactions data—in some embodiments, it may be deleted upon being used for training).

There can be more sophisticated use cases from this variation, where there can be a multistage negotiation that automatically occur behind-the-scenes, where complex logic can be implemented on the website side and the extension side to interrogate one another for dynamic offer generation. For example, the website may be configured to request from the extension, through a hidden field, the user's brand preferences, the color of the running attire the user recently purchased, the shoe size, color preferences, and price range preferences, and through this response, during the checkout page, dynamically generate the bundle promotion. In this example, both the user and the merchant benefit as the offer is truly customized for the user, and the user's extension is capable of both assisting the merchant's website to automatically tailor the offer to an offer that the user would actually be interested in purchasing, while also interrogating the merchant's website for additional deals or promotions to help the user save money in the long term. Finally, as noted below, privacy is a prime consideration and the companion can be tuned to modify the precision of information provided as autofill injected responses by the extension. This precision, for example, can be established through specific privacy logic, or in some embodiments, a shifting slider control between how much edge/which edge level data is permissible for usage, while other, non-private inputs can be generated based on the trained global federated model outputs alone.

The webpage may have a field that is configured to have a webpage hook or other type of identifier that can be triggered by the extension providing a sufficiently persuasive description of the user's purchasing journey, generated in conjunction with any specific privacy settings of the user. In this example, the website can have a field that will dynamically offer “bundle offers” or volume discounts upon a hidden field noting that the user is a user within a specific demographic and their history indicates that this is a back-to-school purchase journey, for example.

If a user is purchasing a school tablet, for example, in the checkout page, they can be dynamically presented with an in-journey offer for an additional discount for drawing accessories for the school tablet that are useful for fine arts students, based on a behind the scenes automatic negotiation between the website and the user's extension, which operates as a smart shopping companion that is able to automatically inject and autofill inputs to automatically request various types of discounts, promotions, or financial products.

As described herein, because of the increased technical complexity of this type of autofill injection and input, the proposed federated/edge computing approach described herein can be used to provide a computationally efficient mechanism for implementing models that not only cooperate in their ability to update and generate outputs, but also are configured with technologically enforced technical protection measures for privacy and security built into the architectures. Accordingly, the approaches provide a useful mechanism that not only helps minimize or distribute a computational burden for more sophisticated backend computations, but the segregated nature of the computations using the federated computing architecture significantly reduces the cybersecurity risk and attack vector surface, as the federated models do not have access to the edge computing data, and accordingly, the injection and insertion can be generated at a local level while also taking advantage of global training on the model. Confidential embeddings and gradients can be used for model updates between global and local and model coordination.

The websites being traversed, while in some embodiments, can be regular websites having regular input fields and pages, as described in some variants herein, can also be configured with specific technical hooks or anchors to automatically invoke or trigger inputs from the extension such that the websites and the extension autofill can automatically or semi-automatically negotiate eligibility for various offers or promotions.

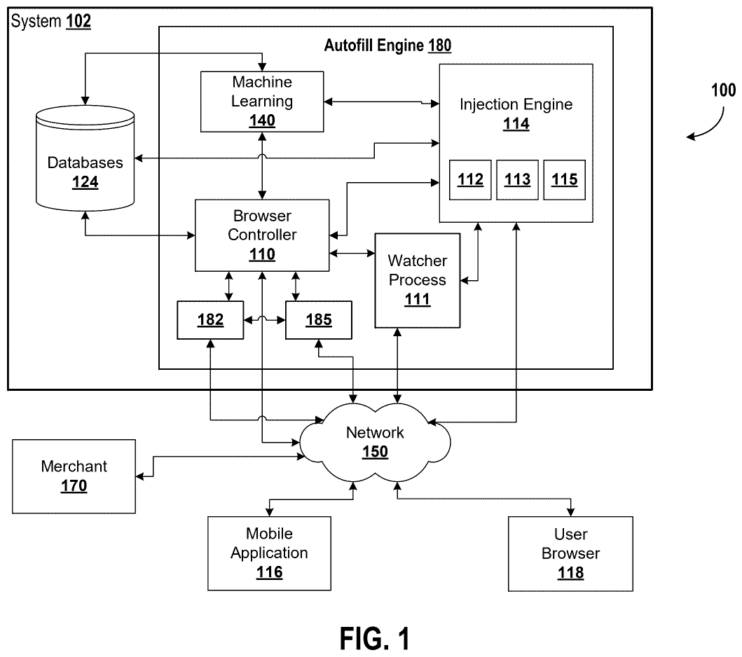

FIG. 1 is a block schematic diagram of an example architecture 100, which includes a system 102 for conducting autofill of one or more input fields in a web page, where the values for the one or more input fields may be generated based on user data or site data, or a combination of both, and may be further refined or generated based on output from a machine learning engine 140.

The system 102 includes a browser controller 110, a database 124 for storing user data and site data, a machine learning engine 140 for generating, when appropriate, predictive values for autofill of one or more input fields in a web page, and an injection engine 114 for generating commands for the autofill of the one or more input fields in a web page. The system 102 can be connected to one or more browsers 118 or mobile applications 116 through a network 150, such as a local area network, or a wide area network, such as an intranet, or the Internet.

The database 124 is configured for periodically or continuously storing user data (e.g., input data from a user device used to browse the web page) and site data (e.g., web data from the web page). For example, through the browser controller 110, one or more data objects from one or more data sets are obtained from the browser 118 or mobile application 116 in real time or near real time, and may be stored in the database 124. These data objects can be provided, for example, in the form of search queries, browsing navigation selections, user input relating to a payment card, billing information and delivery information, payment fulfillment, a shopping cart checkout, and so on.

In some embodiments, the browser controller 110 communicates with a page classifier module 182 to classify each web page and a field classifier module 185 to classify each field within the web page. The classification performed by the page classifier module 182 may be configured to determine if a web page, such as a current web page open in a user browser 118 or mobile application 116 contains at least one input field appropriate for autofill. The classification performed by the field classifier module 185 may be configured to determine if a field in the web page is an input field for autofill. In some embodiments, a trained Field Classifier Model of the field classifier module 185 may be used to detect one or more fields in the web page as input field for autofill.

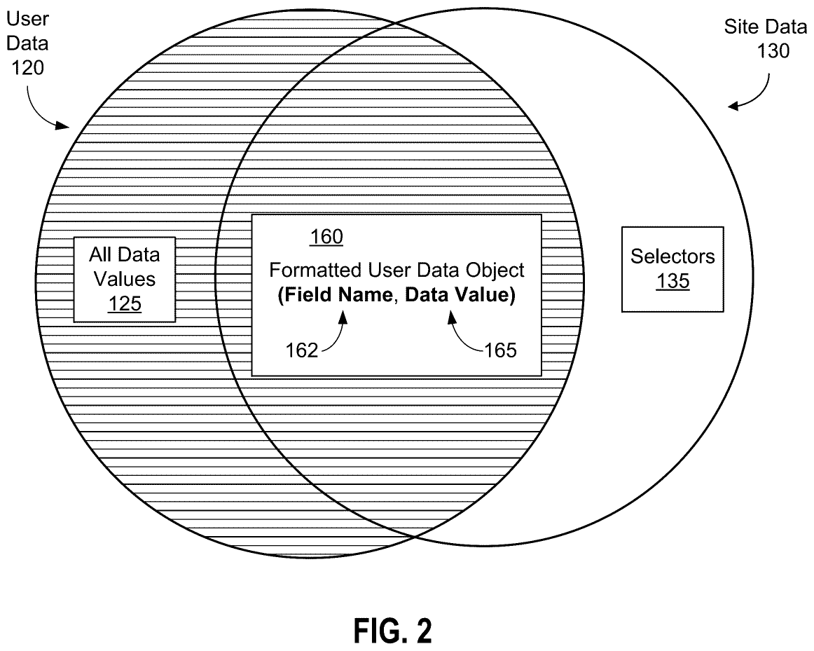

Referring now to FIG. 2, which shows a schematic diagram showing an overlap between user data 120 and site data 130 on a web page. Both the user data 120 and the site data 130 may need to be processed, such as through a series of formatting and modifications or additions, before they can be used to autofill one or more input fields. User data 120 may include data values 125. Site data 130 may be obtained via one or more selectors 135. A selector 135, such as a Cascading Style Sheets (CSS) selector, including for example a name selector, a type selector, a class selector, and an ID selector.

In some embodiments, for example, the name attribute from user data 120 may be used in combination with one or more selectors 135, such as one or more of the type selectors, class selector, and ID selector, to determine a value of a missing attribute.

In some embodiments, for example, a name selector can identify and select a name attribute from site data 130, such as a name attribute from an input element in a Hypertext Markup Language (HTML) web page used to specify a name for the input element, may be used in combination with one or more selectors 135, such as one or more of the type selector, class selector, and ID selector, to determine a value of a missing attribute.

The type selector identifies an element based on its type, e.g., how that element is declared within HTML. The class selector identifies an element based on its class attribute value. The ID selector identifies an element based on its ID attribute value, which is unique and only used once per page.

A site data 130 may include a field name or field set name. A user data 120 may need to be processed into a data object 160 where the corresponding data value 165 is equivalent to the data value 125 of the user data 120, and the filed name 162 is a field name in the site data 130. In addition, the site data 130 may also be processed into an object that can be searched through.

In some embodiments, to start the autofill process of a field given by the site data 130, a selector of the field can be looked up using the query ‘document.queryselector( )’ and if the element is found, the element may be autofilled with the value 165 in user data 120 that corresponds to that field set name 162, which is the key in the formatted user data object 160.

A watcher process 111 can be initialized at the same time to watch for changes of the DOM. This is needed for example, when a checkout scenario has multiple buttons in the flow from shipping details, to a few more clicks needed to get to card details. The watcher process 111 continues until a checkout trigger or button, defined by site data, is clicked, after which the watcher process 111 disconnects and autofill ends.

In some embodiments, the database 124 is connected with one or more merchant ecosystem 170 to retrieve or obtain merchant data, if needed. For example, a merchant ecosystem 170 may be configured to store specific offers or promotions for a particular website. In this case, the database 124 may be using the merchant data to help autofill one or more input fields of in one or more web pages of the website.

In some embodiments, a browser controller 110 of system 102 may cause to install a front-end browser extension (not shown) that interoperates with an existing browser 118 to inject or otherwise modify rendering of information in one or more input fields in a web page rendered on the browser 118, or on a mobile application 116.

The system 102 may, in some embodiments, be configured to intercept web page (e.g., HTML, PHP) or mobile application information (e.g., JavaScript™ object notation or JSON data objects), and to inject (or re-inject if the initial inject fails) values to one or more user interface elements in the web page being browsed by the user, where a browser controller 110 acts to inject the values based on one or more signals from an injection engine 114, which may include an interpreter module 112, an iframe injection module 113 and a reinjection module 115.

The interpreter module 112, through browser controller 110, may cause a watcher process 111 or thread to be initiated and configured to monitor one or more changes on the web page, or a number of web pages in order to determine if any autofill attempt should be made.

The browser controller 110 can be configured to interface with different types of front-end clients, such as mobile applications 116 having an embedded user interface for shopping, an end-user browser 118 that may include native functionality, and interface calls for interoperating with the system 102. For example, the browser controller 110 can generate electronic signals for autofill of predictive values at a user interface presented at the end user browser 118 through the provisioning of signals and control instructions to render the values.

The browser controller 110 can be configured to, in some embodiments, to intercept web page (e.g., HTML, PHP) or mobile application information (e.g., JavaScript™ object notation (JSON) data objects). The intercepted information can be obtained in different ways, such as using an HTTPS proxy for routing interaction information directly from the mobile application 116 or a browser 118, selectively transmitting information extracted by a browser extension, or through the use of an inspect element tool to allow the accessing of a source code of a web page or a merchant interface.

User input information or user data can also be tracked, such as specific clicks, keyboard entries, touch inputs, speech input, including those that relate to the navigation through or queries using the user interface.

The browser controller 110 (or the injection engine 114) can initiate and configure a watcher process 111, for each browsing session launched at browser 118 or mobile application 116, for a particular web page, track or monitor one or more features or elements of the web page or multiple web pages in a website. For example, the watcher process 111 may detect a change in a document object model (DOM) structure associated with the web page. For another example, the watcher process 111 may detect a change in one or more HTML codes used to render the user interface on the web page. For yet another example, the watcher process 111 may detect a change in dynamic elements such as a selector element on the web page. Each time any change or occurrence of a new data element is detected, the browser controller 110 can send a corresponding signal to the injection engine 114 notifying the change.

In some embodiments, the browser controller 110, through the watcher process 111, may generate a watcher instance, as part of injected content script, to read or interrogate a DOM structure associated with the web page, in order to determine if a change or modification has occurred within the web page.

The browser controller 110 may also detect an iframe within a web page, or within a DOM of a web page. For instance, the controller 110 may use the watcher process 111 to detect an iframe in a web page. In some embodiments, a listener instance may be generated by the watcher process 111 or the browser controller 110 to monitor an iframe trigger, which may be for example an iframe tag within a DOM structure of a web page. In some embodiments, iframe trigger or tag may be passed from the browser of a user device to a background script, and subsequently detected by the listener instance.

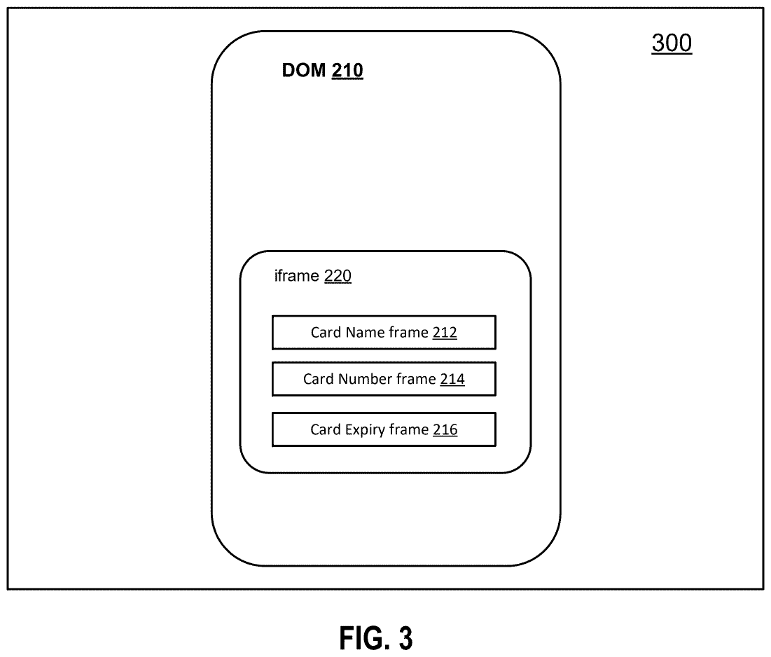

An iframe, or an inline frame, is a HTML element that loads a separate HTML page within a web page. Typically, an iframe is specified by a tag in the HTML code used to render the web page, such as an <iframe> tag. Referring now to FIG. 3, which illustrates an example website 300 implemented using DOM 210. DOM 210 may contain an iframe 220. The iframe 220 may include one or more input fields or frames, such as card name frame 212, a card number frame 214 and a card expiry frame 216.

Example DOM structures that can be detected can include, for example, navigational buttons on the pages (back and forward arrows among others), action buttons (pay now, place order, purchase) and others.

In some embodiments, a checkout process on an eCommerce website may implement iframes as a secure container for receiving and containing payment details. An iframe is a html element that loads a separate html element inside of itself and is essentially like a barricaded island in the middle of the DOM. Inside the payment iframe 220, although there is still a card number, card expiry and card name, the selectors change on every page load and refresh. Therefore, the traditional method of autofill cannot work since the selector is changed at random. The system 102 is implemented to overcome this problem by implementing the browser controller 110 and the injection engine 114.

The injection engine 114 includes an interpreter module 112, which is configured to obtain, from browser 118, user data 120 and site data 130, including one or more values representing a payment information (e.g., payment card details). It is the starting point where autofill is attempted and configures whether a second round of autofill, iframe injection or reinjection is required. A watcher process 111 as described above may be initiated by interpreter module 112 to monitor any changes on the website to help with determination regarding subsequent attempts of autofill.

If there is an iframe trigger from the site data 130, such as the <iframe> tag, iframe injection module 113 is called upon to initiate a dormant script that is waiting in all frames and once signalled by the background script, may be executed to attempt autofill of one or more input fields in the iframe within a web page.

In some embodiments, the reinjection module 115 is needed in a checkout scenario with iframes, and when a next step button needs to be clicked to continue entering shipping, billing and card information. When the browser controller 118 detects that a next step button during the checkout process is clicked by a user, a second or subsequent round of attempt of injection or autofill is performed by the reinjection module 115, so that after every user input (e.g., click) on the next step button, autofill can continue, injecting values into iframes for card details. The autofill process can end when the final checkout button “pay now” or similar is clicked by the user in the checkout process.

Example DOM structures that can be detected can include, for example, navigational buttons on the pages (back and forward arrows among others), action buttons (pay now, place order, purchase) and others.

For example, the system 102 is able to successfully autofill shipping, billing and payment card details in a variety of checkout scenarios and into any iframe-supported checkout process.

The interpreter module 112 through the watcher process 111 can monitor for changes of the Document Object Model (DOM), and further cause, when appropriate, an iframe injection, or reinjection, and end once a final checkout button is clicked.

The browser controller 110 may, in some embodiments, identify the structure of a web page or a response message (e.g., through interrogating a DOM structure), and directly modify the rendered user interface through the identification of sections in the DOM structure, and further cause to modify, add, or transform one or more web elements or code snippets to perform autofill of values in one or more input fields of a web page rendered at browser 118 or mobile application 116. Throughout this disclosure, autofill of values on a web page may be referred to as “injection” or “reinjection”.

Collectively, the browser controller 110, watcher processor 111, injection engine 114, machine learning engine 140, page classifier module 182 and field classifier module 185 may be referred to as an autofill engine 180. The autofill engine 180 is responsible for determining if and when a web page requires autofill, and proceeds to perform the required autofill action, including for example, generation of predicted values for one or more fields within the web page and filling the fields with the generated predicted values.

In some embodiments, autofill of values may occur to fill text input elements (e.g., name, street address) only. In some embodiments, autofill of values may occur to fill text input elements as well as other types of elements, such as, for example, to select an option presented in a select element, which renders a plurality of options (e.g., select drop-down list created by HTML <select> tag). Select elements may be used for province and country, or for credit card expiry months and years. The browser controller 110 may identify the structure of a webpage or a response message (e.g., through reading or interrogating a DOM structure), and directly modify the rendered user interface through the identification of sections in the DOM structure, then further modify, add, or transform one or more web elements or code snippets to perform autofill of values in one or more fields of a webpage, including text input elements and select elements, in the rendered at browser 118 or mobile application 116. Other types of input elements may be autofilled as well, including for example, button element, checkbox element, date element, email element, radio element, range element, and so on.

During a checkout process which may span multiple checkout web pages, the system 102 can, through browser controller 110, collect web forms and data such as shipping address, contact information, and payment information (e.g., credit card details), and predicting, via the machine learning engine 140, respective label(s) of each of the input fields in a given form. For example, input fields with text types can be predicted with high accuracy.

In some embodiments, a dormant script, separate from all existing content and background scripts, may be initialized by the injection engine 114. The dormant script has a manifest file, which has the value of “all_frames” set to true. By this set up, the dormant script is configured to wait in each frame and can successfully autofill in one or more input fields, such as card name frame 212, a card number frame 214 and a card expiry frame 216.

To start the script, the injection engine 114 first makes a browser send a message to the background script, which in turn sends another message “iframeInject”. The dormant script has a listener for the “iframeInject” call, and only after the page and all frames have loaded, will cause the iframe injection module 113 to start iframe injection, e.g., autofill one or more input fields in the web page. In some embodiments, the iframe injection or autofill may be implemented with an interval to try obtaining the web element and then perform autofill of the input field with an appropriate value. This interval is set to a period above a minimum threshold (e.g., 1000 ms) so that the iframe does not recognize the autofill action or block the autofill process. After the interval is up, the iframe injection process ends.

In some embodiments, the watcher process 111 or the browser controller 110 may be configured to determine if a web page contains an iframe page. For instance, content or dormant script can be configured to pass a message to background script if and when an iframe is loaded or running within a current web page, and the background script may communicate with the autofill engine 108 of system 102 over the network 150 to relay that an iframe page is loaded. The content script may include, for instance, the watcher process 111 to look for an iframe tag within the HTML elements of a DOM structure of the web page. When an iframe tag is located by the watcher process 111, the content or dormant script may send a message to the background script indicating the same, which means that an iframe page has been loaded within the current web page.

Once it is determined that an iframe page has loaded within a current web page, a listener instance may be initiated for the iframeInject call and continue with injection, as configured by the injection engine 114. In this manner, the iframeInject call is only launched after the iframe with the dormant script has been initialized, which eliminates or reduces errors with injection/mistiming.

In some embodiments, the dormant script may be in every iframe, but the listener is only initialized for the IframeInject call in payment frames that have been identified corresponding to the payment fields requiring autofill. In this manner, generation of values and autofilling of input fields in iframes are only performed when the iframe is identified (e.g., by the page classifier module 182) to include at least one field requiring autofill. For instance, the iframe page may be part of a checkout process, which may require autofill of payment card information. And when the iframe page is unrelated to autofill, such as a Google™ analytics frame, the autofill of values will not be triggered, and a timing interval is not required.

The reinjection module 115 in the injection engine 114 is a third component for an autofill process. Typically, in websites using iframes spanning multiple web pages, the checkout process is separated into multiple pages, a “next” button is placed at each page to proceed to the next check out page, and a final checkout button is at the second last web page before payment card is taken for processing.

A final checkout button typically indicates that the checkout process is reaching a final stage, that is, all payment, billing and shipping information has been received and autofilled where appropriate. Therefore, during a typical autofill process, the watcher process 111 may be configured to use a query (e.g., jQuery # id selector) to look for an ID attribute of an HTML tag to find the specific element corresponding to the final checkout button.

In some embodiments, the watcher process 111 may be configured to use a JavaScript™ document.querySelector or .querySelectorAll, which are Document methods, to look for an ID attribute of an HTML tag to find the specific element corresponding to the final checkout button.

In some embodiments, the browser controller 110 communicates with a page classifier module 182 to classify each web page and a field classifier module 185 to classify each field within the web page. The classification performed by the page classifier module 182 may be configured to determine if a web page, such as a current web page open in a user browser 118 or mobile application 116 contains at least one input field appropriate for autofill. The classification performed by the field classifier module 185 may be configured to determine if a field in the web page is an input field for autofill.

In some embodiments, a page classifier module 182 may be initiated and monitored by browser controller 110 to read and analyze information on a web page, in order to determine if the web page includes at least one input field for autofill. For instance, the page classifier module 182 may be configured to analyze the html elements such as html tags and text to determine if the web page is a part of a checkout process, including a payment page.

For instance, a page classifier module 182 can include a module implemented based on Term Frequency-Inverse Document Frequency (TFIDF) used to determine relevancy of the web page as it relates to one or more topics or search terms. The page classifier module 182 is configured to perform text mining based on TFIDF by analyzing, for each web page, all elements including tags, text data, and other information in order to determine one or more keywords and their associated respective frequency and respective weights, the keywords or terms with higher weight scores are considered to be more relevant or important. Using this method, the page classifier module 182 can determine a current web page is most likely part of a checkout process, or more specifically, a payment process including an input field for payment information, when the relevant TFIDF score is above a predetermined threshold.

A field classifier module 185 can be initiated by browser controller 110 when a page classifier module 182 has determined that a web page includes at least one input field requiring autofill. The field classifier module 185 can be configured to classify each input field on the web page as whether it is an appropriate input field for autofill, and if so, the type of input required (e.g., delivery address or payment card). The classification by field classifier module 185 may be performed by a machine learning model, such as machine learning model 140, which may include trained machine learning models for text mining and text analysis, such as, for example, machine learning models implemented based on gradient-boosting (e.g., using XGBoost Algorithm).

Injection process performed by the injection model 114 can occur after the page classifier module 182 has determined that a current web page has at least one input field needing autofill, and the field classifier module 185 has determined the exact input fields for autofill of one or more values. For instance, if a current web page is the start of a checkout or payment process, and after a user consent has been obtained, the machine learning model 140 may be executed to generate one or more predicted values for one or more input fields within the current web page, and the injection model 114 may be launched by the browser controller 110 to start injection process.

In some embodiments, in websites using iframes spanning multiple web pages, the checkout process is separated into multiple pages, a “next” button (for proceeding to the next page of checkout process) may appear to be the same type as the final checkout button, i.e., having the same ID attribute/HTML tag, or corresponding to the same ID selector.

This means that in a typical autofill process, an autofill or injection process may be configured to end after receiving indication that the final checkout button is clicked, which means a typical or first autofill action may in fact end after a first set of user data (e.g., shipping information) has been entered, but remaining information is still missing when the user clicks on the “next” button. The injection engine 114 can, in these cases, check in the browser's local storage process to determine, when appropriate, whether iframe injection or reinjection should proceed, as described below.

For example, during a multi-page checkout. The reinjection module 115 is configured to send out a message “reinject” to a background script, where the background script then stores the key-value pair “autoInject, reinject” into the browser's local storage. In addition, the reinjection module 115 listens for that call and checks if that key-value pair exists in local storage. If “autoInject, reinject” key-value pair exists, a ‘browser.webNavigation.onCompleted.addListener( )’ is added. Once it is loaded, it triggers to run a reinject handler to gather the user data 120, site data 130 and payment card information again, and re-initialize the interpreter module 112. This restarts the cycle of trying to autofill, retrying the autofill process if it's a new page, and finally at the end with the payment details, starting the iframe injection process.

After multiple rounds of checking and starting the iframe injection process, and once the checkout button is clicked, an end-inject command may clear the browsers local storage specifically of that key-pair and the autofill cycle has ended.

In some embodiments, checkout web pages are type of web forms with wide variety in field names, position of the fields and its attributes. Machine learning techniques implemented in the machine learning engine 140 can be used to automatically fill out checkout forms by learning the patterns in the form fields and their order, which can provide more scalable and robust autofill of one or more input fields on a web page during the checkout process.

Machine learning engine 140 may be, in some embodiments, configured to receive at least one of user data and site data and generate predictive values for autofill of one or more input fields in a web page. In some embodiments, the machine learning engine 140 may include transformer-based machine learning models for performing value prediction. In some embodiments, machine learning engine 140 may be configured to generate a determination if an iframe exists within a given web page.

The machine learning engine 140 can be optimized, through supervised training using prior tracked results, or reinforcement learning using real-world results, to generate predictive values for autofill of one or more input fields in a web page based on the at least one of user data and site data.

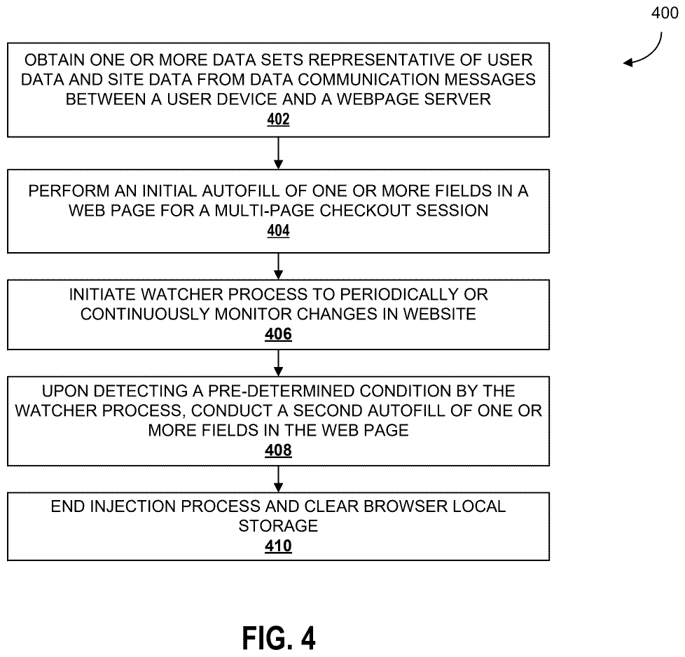

FIG. 4 is an example process 400 performed by the system in FIG. 1 for performing autofill of one or more input fields in a web page of a website, according to some embodiments. At operation 402, the system 102 obtains one or more data sets representative of user data 120 and site data 130 from data communication messages between a user device and a web page server.

At operation 404, the system 102 performs an initial autofill (“injection”) of one or more input fields in a web page for a multi-page checkout session. This may be performed, for example, by an injection engine 114, such as iframe injection module 112 of the injection engine 114.

In some embodiments, an autofill of a field in the web page comprises injecting, into an instruction set for loading user interface (UI) elements on a user interface for the web page, a value based on at least one data item from the user data 120.

In some embodiments, the value may be part of payment card information.

In some embodiments, the value may be one of: a name, a credit card number, an expiry date, a billing address, and a telephone number.

In some embodiments, the value may be part of delivery information.

In some embodiments, the value may be one of: a name, a shipping address, a telephone number, and an e-mail address.

At operation 406, which may happen at the same time as operation 404, a watcher process 111 is initiated by the system 102, such as by the interpreter module 112 of injection engine 114, to periodically or continuously monitor changes in website (e.g., DOM tree, separate HTML elements, selectors in site data 130).

In some embodiments, the watcher process 111 is configured to monitor changes in the Document Object Model (DOM).

In some embodiments, the watcher process 111 is configured to monitor changes in one or more selectors in the site data.

The watcher process 111 monitors site data to identify iframe triggers (e.g., such as the <iframe> tag), to prepare for a checkout scenario with one or more next step or “next”buttons.

At operation 408, upon detecting a pre-determined condition by the watcher process 111, a component of the system 102, such as the reinjection module 115, may conduct re-injection or second round of autofill action. In some embodiments, the second round of autofill action may be performed with a delay of an interval (e.g., 1000 ms).

In some embodiments, an example pre-determined condition may be, for example, an iframe trigger detected by a listener (e.g., event listener), a modal appearing, or an additional new input field relating to a checkout process that has not yet been processed.

In some embodiments, the second autofill is only conducted when the initial autofill fails.

In some embodiments, one or more one or more values used for autofill for the one or more input fields are using a machine learning model executing a trained machine learning algorithm. Such a machine learning model may be implemented by way of machine learning engine 140, for example.

Machine learning engine 140 may be, in some embodiments, configured to receive at least one of user data and site data and generate predictive values for autofill of one or more input fields in a web page. In some embodiments, machine learning engine 140 may be configured to generate a determination if an iframe exists within a given web page.

The machine learning engine 140 can be optimized, through supervised training using prior tracked results, or reinforcement learning using real-world results, to generate predictive values for autofill of one or more input fields in a web page based on the at least one of user data and site data.

At operation 410, the system 102 can end injection or autofill process and clear browser local storage.

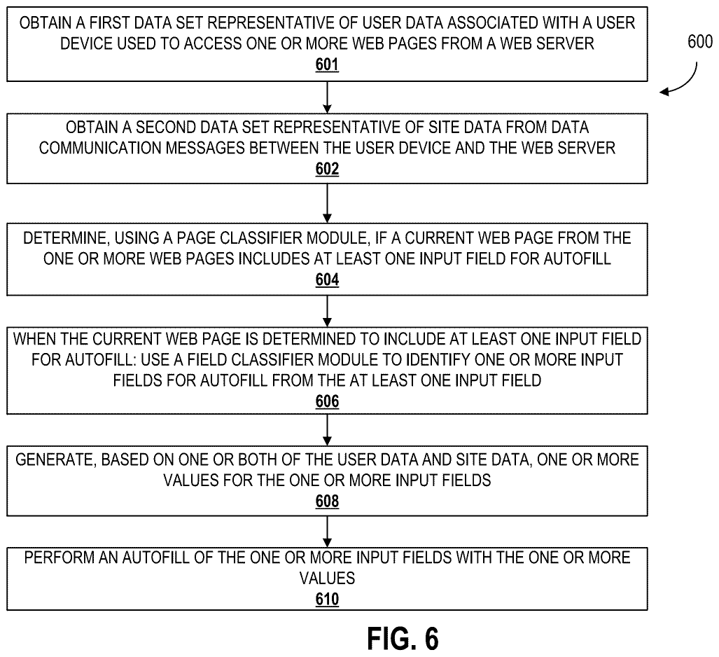

FIG. 6 shows another example process 600 performed by the system in FIG. 1 for performing autofill of one or more input fields in a web page, according to some embodiments.

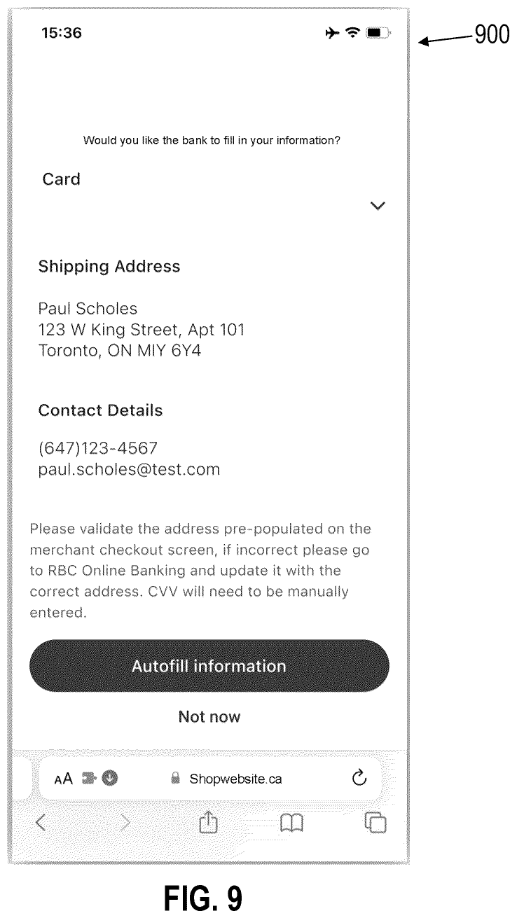

At operation 601, the system 102 obtains a first data set representative of user data associated with a user device used to access one or more web pages from a web server. For instance, FIG. 9 shows an example of screen capture 900 of a user interface displaying user data that can be validated by a user via one or more user input fields “autofill information” or “not now”. As shown, user data such as name, address, post code, last four digits of a credit card, telephone number and email address may be displayed to the user prior to being updated and saved for later autofill application.

At operation 602, the system 102 obtains a second data set representative of site data from data communication messages between the user device and the web server.

At operation 604, the system 102 determines, using a page classifier module 182, if a current web page from the one or more web pages includes at least one input field for autofill.

In some embodiments, the browser controller 110 communicates with a page classifier module 182 to classify each web page and a field classifier module 185 to classify each field within the web page. The classification performed by the page classifier module 182 may be configured to determine if a web page, such as a current web page open in a user browser 118 or mobile application 116 contains at least one input field appropriate for autofill. The classification performed by the field classifier module 185 may be configured to determine if a field in the web page is an input field for autofill.

In some embodiments, a page classifier module 182 may be initiated and monitored by browser controller 110 to read and analyze information on a web page, in order to determine if the web page includes at least one input field for autofill. For instance, the page classifier module 182 may be configured to analyze the html elements such as html tags and text to determine if the web page is a part of a checkout process, including a payment page.

For instance, a page classifier module 182 can include a module implemented based on Term Frequency—Inverse Document Frequency (TFIDF) used to determine relevancy of the web page as it relates to one or more topics or search terms. The page classifier module 182 is configured to perform text mining based on TFIDF by analyzing, for each web page, all elements including tags, text data, and other information in order to determine one or more keywords and their associated respective frequency and respective weights, the keywords or terms with higher weight scores are considered to be more relevant or important. Using this method, the page classifier module 182 can determine a current web page is most likely part of a checkout process, or more specifically, a payment process including an input field for payment information, when the relevant TFIDF score is above a predetermined threshold.

At operation 606, when the current web page is determined to include at least one input field for autofill: the system 102 uses a field classifier module 185 to identify one or more input fields for autofill from the at least one input field.

A field classifier module 185 can be initiated by browser controller 110 when a page classifier module 182 has determined that a web page includes at least one input field requiring autofill. The field classifier module 185 can be configured to classify each input field on the web page as whether it is an appropriate input field for autofill, and if so, the type of input required (e.g., delivery address or payment card). The classification by field classifier module 185 may be performed by a machine learning model, such as machine learning model 140, which may include trained machine learning models for text mining and text analysis, such as, for example, machine learning models implemented based on gradient-boosting (e.g., using XGBoost Algorithm).

At operation 608, the system 102 generates, based on one or both of the user data and site data, one or more values for the one or more input fields.

At operation 610, the system 102 performs an autofill of the one or more input fields with the one or more values.

Injection process performed by the injection model 114 can occur after the page classifier module 182 has determined that a current web page has at least one input field needing autofill, and the field classifier module 185 has determined the exact input fields for autofill of one or more values.

In some embodiments, the system 102 initiates a watcher process 111 (e.g., via browser controller 110) to periodically or continuously monitor changes in the current web page, performs an initial autofill of the one or more input fields in the current web page; and upon detecting a change on the current web page, performs a second autofill of the one or more input fields in the current web page.

Upon detecting a pre-determined condition by the watcher process 111, a component of the system 102, such as the reinjection module 115, may conduct re-injection or second round of autofill action.

In some embodiments, the system 102 launches the watcher process 111 when the page classifier module 182 has determined that the current web page includes at least one input field for autofill. For instance, the page classifier module 182 may determine that the current web page is part of a checkout process or payment process, and therefore includes at least one field for autofill.

In some embodiments, the system 102 initiates the watcher process 111 at the same time as it initiatives the page classification module 182.

In some embodiments, the watcher process 111 is configured to monitor changes in a Document Object Model (DOM) associated with the current web page. In some embodiments, the watcher process 111 is configured to monitor changes in one or more selectors in the site data.

As mentioned, the watcher process 111 is used to detect new changes or modifications to the same web page, and whenever a change or modification is detected in the web page, a field classifier module 185 is launched again to determine one or more input fields for autofill in the web page.

In some embodiments, an example pre-determined condition may be, for example, an iframe trigger detected by a listener (e.g., event listener), a modal appearing, or an additional new input field relating to a checkout process that has not yet been processed.

In some embodiments, performing an autofill of the one or more input fields with the one or more values includes: simulating a user-agent; and injecting, into an instruction set for loading user interface (UI) elements on a user interface for the current web page, a value from the one or more values, the value generated based on at least one data set from the user data.

Based on a structure or architecture of the current web page and in order to correctly set the value of an input field, a unique combination of HTML events need to occur, or detected by the server as having been caused by a user-agent. This ensures that the HTML element accepts the change in value and any UI that changes associated with it occurs (such as hoisting of labels).

One implementation to simulate a user-agent is to set the values of all elements and ensure that it is accepted with a unique sequence of these events that in the right order simulate a user-agent to the best of its abilities. Through the simulation and sequence of click, focus, input, change, blur, focusout and mouseout, the HTML element accepts the change or update of value, and the injection process by the injection engine 114 can be successful.

In some embodiments, simulating the user-agent includes simulating a sequence of Hypertext Markup Language (HTML) events configured to simulate actions of the user-agent.

In some embodiments, an example user-agent simulation may include ID, name, combination of input to simulate the user-agent, which may be a software that retrieves, renders and facilitates end user interaction with Web content, or whose user interface is implemented using Web technologies.

In some embodiments, a user-agent can be a web browser used to communicate with a web server to identify itself and provide information about the browser's capabilities. The user-agent string can include information such as the browser type and version, the operating system, and the device type.

In some embodiments, a listener is launched within a content or dormant script of the web page to detect an iframe trigger, in parallel to the page classifier module 182 being running to classify a given web page. The content or dormant page can listen to an occurrence of an iframe element or tag, and passes this information to background scrip that talks to the autofill engine 118 of system 102.

In some embodiments, the sequence of HTML events is pre-determined based on a type of input field from the one or more input fields.

For example, for a given type of input field, the sequence of HTML events may include, in the following order: touchstart, click, touchend, focus, focusin, input, change, blur, focusout, and mouseout.

The HTML events may be simulated by the following string:
var changeEvent=new Event(‘change’, {bubbles: true, cancelable: false});
element.dispatchevent(changeevent).

In some embodiments, the system 102 can initiate a listener when a dormant script associated with the current web page indicates that an iframe is loaded as part of the current web page; and upon detecting, by the listener, that the iframe loaded is related to a checkout or payment process, perform autofill of one or more payment fields in the iframe loaded.

In some embodiments, the one or more one or more values used for autofill for the one or more input fields are generated using a machine learning module 140.

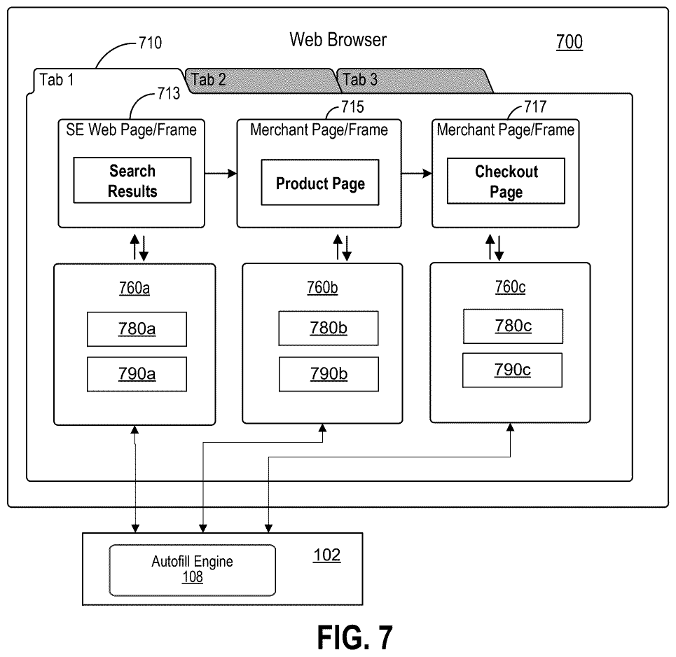

FIG. 7 shows an example web browser with multiple web pages in communication with an autofill engine 108 of system 102, in accordance with some example embodiments. A browser 700 may have multiple tabs 710 open, and one active tab 710 may visit multiple webpages 713, 715, 717 in a sequential order. For example, search results may be displayed at a first webpage 713, then a product page 715 may be launched upon being clicked or tapped by user, the user may then proceed to a checkout page 717. Throughout the whole process, multiple groups of content scripts 780a, 780b, 780c and background scripts 790a, 790b, 790c may actively listen at each web page. A pair 760a, 760b, 760c of content script and background script may also be implemented in the form of a browser extension. At least all of the background scripts 790a, 790b, 790c are in communication with the autofill engine 108 of system 102 in order to determine if any given web page is appropriate for or requires autofill.

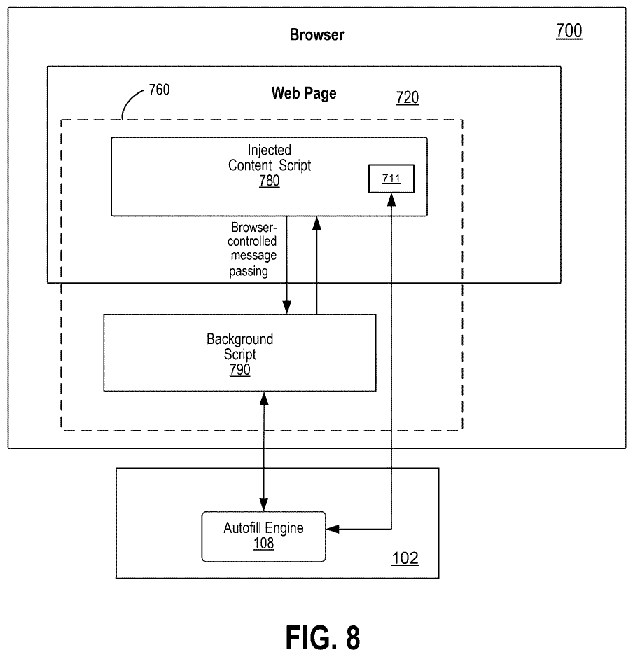

FIG. 8 shows an example web browser 700 with a web page 720 being autofilled by an autofill engine 108 of system 102, in accordance with some example embodiments. In a pair 760 of injected content script 780 (e.g., JavaScript™ files) and background script 790, code containing the content script run in the context of web pages and can modify the content of a page or interact with the page's Document Object Model (DOM). For example, autofill engine 108 can cause (e.g., via injection engine 114) to inject content script 780, which can communicate with a corresponding background script 790 via browser-controlled message passing. Scripts and data in this tier share a common browser context, accessible by the host domain (e.g. Merchant or Payment Service Provider). The injected content script 780 may include, for example, a watcher instance 711 initiated by the watcher process 111.

### Application of Autofill of Input Fields in Web Pages

In a health information system, patients health information, including health card information, diagnosis reports, medical history, allergy reactions, vaccinations, treatment information plans, test results, and so on, are collected, stored and managed. A patient may visit different websites or mobile applications, each directed to a different health care entity: a medical professional, a hospital, and a pharmacy, in order to receive one or more treatments or one or more diagnosis. All of these different health care entities may each has a different information technology system in place, or require an online user to login and provide identifying information (e.g., insurance information or health card number), prior to allowing the user access to healthcare services or drugs. With the autofill engine 108 and the system 102 discussed herein, computational efficiencies can be achieved, and computational resources saved, when at least a certain set of user data (e.g., name, address, insurance information, health card number) are autofilled across all health care entities and their respective websites.

In addition, medical reports may be autofilled when the user has given explicit permission and consent for using said medical reports by the autofill engine 108. For instance, a psychologist report from a psychologist stored in the health information system for patient Sarah D. may include input fields requiring one or more values or statements from stored doctor notes from a family physician for the same patient, and the autofill engine 108 and the system 102 may retrieve the doctor notes as user data, reviewing the psychologist report to identify one or more input fields for autofill, generate the appropriate values for the one or more fields based on the doctor notes, and perform autofill using injection engine 114, in accordance with the embodiments described herein.

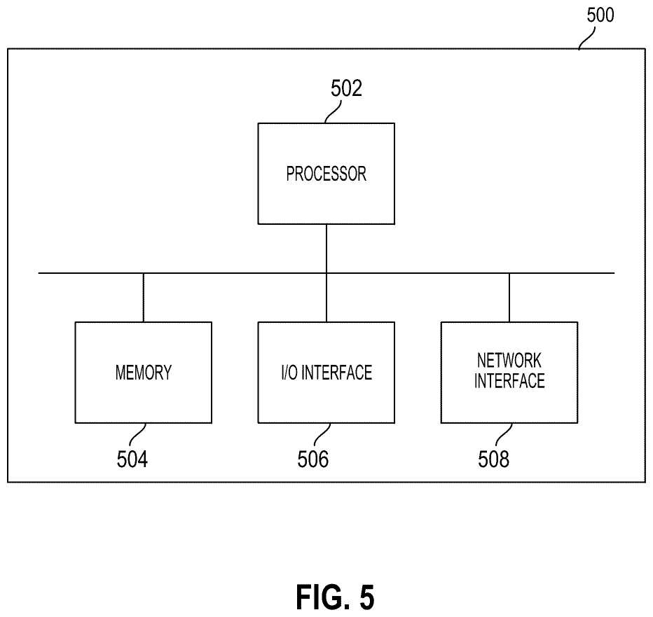

FIG. 5 is a schematic diagram of an example computer device 500 that may be used to implement the system 102 in FIG. 1 for performing autofill of one or more input fields in a web page of a website, according to some embodiments. As depicted, computing device 500 includes one or more processors 502, memory 504, one or more I/O interfaces 506, and one or more network interfaces 508.

When computing device 600 is part of the system 102, for example, at least the autofill engine 108 transforms the system 102 into a special purpose machine that is capable of performing autofill in one or more input fields within one or more web pages to deliver a seamless user experience. For instance, the look and feel of a website or web page rendered by the browser 700 are based in part on content script injected by the autofill engine 108, which are managed by the components of autofill engine 108 and system 102 as described herein.

Each processor 502 may be, for example, a microprocessor or a microcontroller, a digital signal processing (DSP) processor, an integrated circuit, a field programmable gate array (FPGA), a reconfigurable processor, a programmable read-only memory (PROM).

Memory 504 may include a suitable combination of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM). Memory 504 may store code executable at processor 502, which causes system 102 to function in manners disclosed herein. Memory 504 includes a data storage. In at least some embodiments, the data storage includes a secure datastore. In at least some embodiments, the data storage stores received data sets, such as textual data, image data, or other types of data.

Each I/O interface 506 enables computing device 500 to interconnect with one or more input devices, such as a keyboard, mouse, camera, touch screen and a microphone, or with one or more output devices such as a display screen and a speaker.

Each network interface 508 enables computing device 500 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

### Federated Learning (FL) and Local Model Deployment

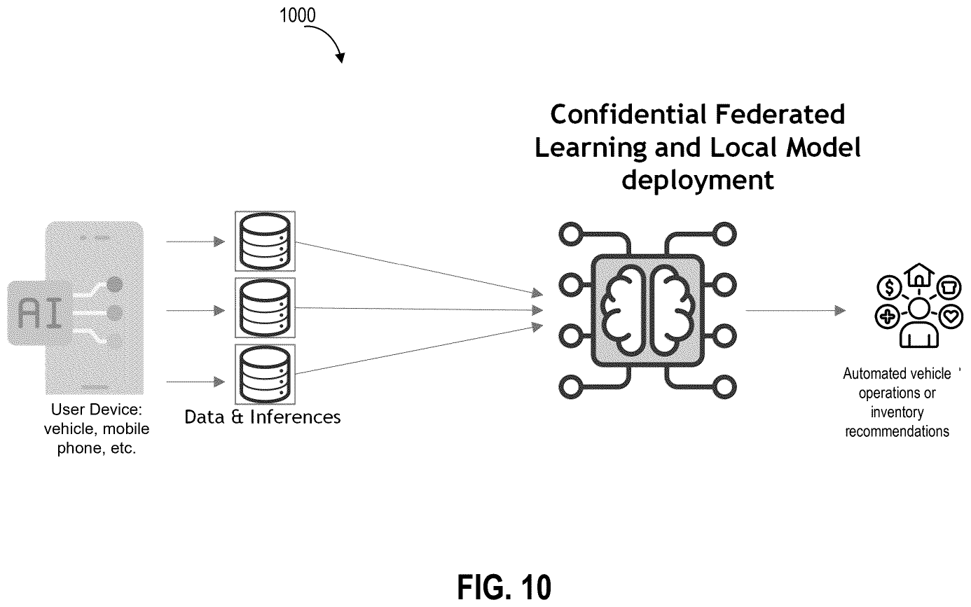

Referring now to FIG. 10, which shows a schematic diagram 1000 illustrating a simplified concept of federated learning (FL) architecture and local model deployment. In the FL architecture as illustrated herein, deployment of machine learning models among multiple, individual client devices are implemented for collaborative training using training data stored locally, which provides data privacy, security, and legal adherence.

As an example of practical application, machine learning techniques are commonly deployed for large-scale training of autonomous vehicles with a significant amount of user data, which include user-specific information such as GPS tracking data, driving records, and so on. At the same time, a large number of machine learning (ML) models are often deployed for the operation of each autonomous vehicle, such as, for instance, ML models for object detection, GPS tracking, point cloud signal processing, radar signal processing, trajectory estimation, and so on. Using federated learning, sensitive user information such as GPS data and driving habits may be gathered and stored locally (e.g., at a computing unit onboard the vehicle or on a user's device), and used for training one or more machine learning models for autonomous driving, but not transmitted outside of the local device.

In the FL architecture, trained machine learning models may collaborate with other trained machine learning models (e.g., by sharing weights or model updates) from other vehicles to enable each respective vehicle to learn and operate based on the collective wisdom of all the ML models that are trained on different user data, in different geographical locations and weather conditions, with different pedestrians behavior dynamics, while preserving data privacy of each respective user of the vehicle. That is, the FL architecture achieves efficient collaborative model training and iteration while ensuring data privacy and security. In some embodiments, a central server, as part of the FL architecture, may be implemented to facilitate the training and fine-tuning of the ML models by acting as a central aggregator, which receives and consolidates the model updates from the ML models to construct a global machine learning model. The central aggregator does not, however, receive raw user data from any vehicle, thereby mitigating risks of user data security breaches or privacy violations.

In some embodiments, FL may be implemented to, based on locally collected and stored data, generate intelligence regarding user preferences and to generate output configured to automate inventory recommendations and payment process at inference time. The locally stored data may be used to train one or more machine learning models deployed on a client device (“edge device”) in the FL architecture. The locally deployed machine learning models may be in some embodiments compressed. The training data may be deleted after each training cycle, as to preserve data privacy.

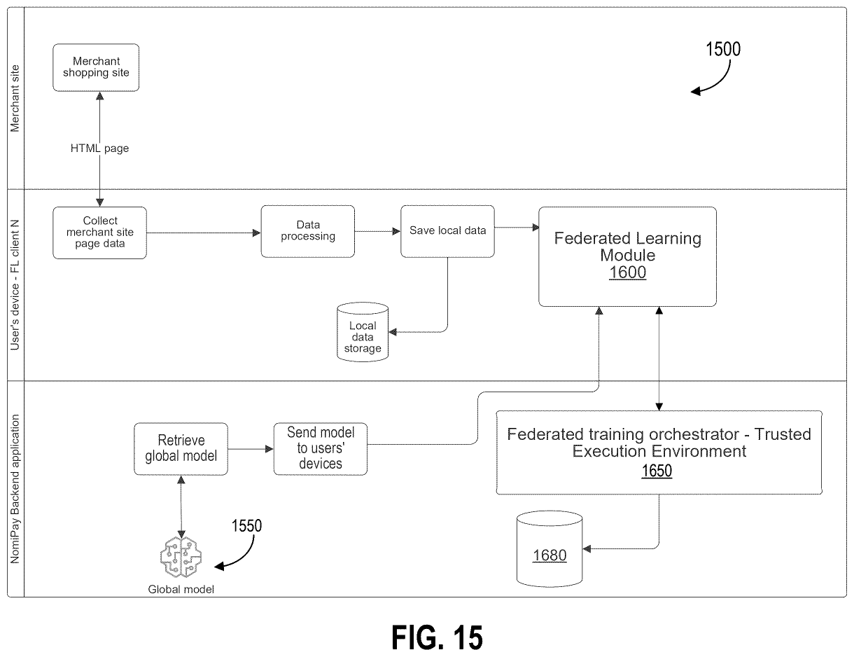

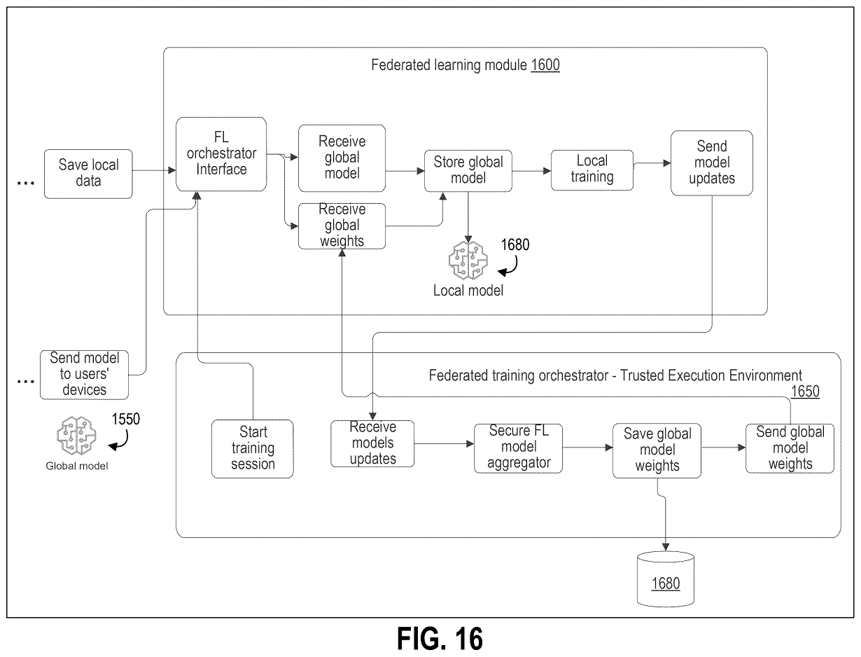

FIGS. 15 and 16 illustrate an example flow chart 1500 illustrating a process of training and updating FI-trained local machine learning models. An example system may train and update local ML models for classifying merchant site pages or fields, by employing a federated learning (FL) workflows across multiple user devices. Each user device may have an FI learning module or client 1600 configured to work with a federated training orchestrator 1650 on a central aggregator server, to train the local ML models 1680 to generate model updates, which are transmitted to the federated training orchestrator 1650. The federated training orchestrator 1650 receives model updates (e.g., weights, parameters) from each user device and aggregate the model updates to generate global model update, which can be stored in a global weight database 1680.

The federated training orchestrator 1650 may send the global model update to the FI learning module or client 1600 on user device, which also receives a current version of global model 1550 from the server hosting the federated training orchestrator 1650. The FI learning module or client 1600 is configured to generate an updated global model based on the current version of global model 1550 and the global model update, and store the updated global model as the new local model 1680. In an iterative training process, the local ML model 1680 is trained and refined using local data each time a pre-defined condition or threshold is met. For example, the condition may be a size limit of the local data on the user device, or it may be a time limit (e.g., the local ML model 1680 is updated every day/week/month).

Multiple trained machine learning models on local client devices may, in a FL architecture, communicate respective model updates (e.g., parameters or weights in a vector or matrix representation) to a central aggregator or to one another. In some embodiments, the local machine learning model(s) across multiple client devices in a FL architecture may have a common global model. In some embodiments, the local machine learning model(s) across multiple client devices in a FL architecture may have the same number of layers for a respective neural network.

In a FL architecture, client devices may encounter technical problems such as insufficient storage, insufficient communication bandwidth, and network latencies. By compressing the local machine learning models, the communication and storage device overhead may be reduced, model size and communication cost are reduced while retaining most of model accuracy, which lead to improved efficiency and scalability of federated learning. Model compression further provides data privacy and security, since data contained in the models are compressed and obscured.

Example model compression techniques may include, as non-limiting examples, quantization technique for reducing number of bits used to represent the model parameters or outputs, sparsification technique for conversion of dense model parameters or outputs into sparse representations (e.g., using zero values), or distillation technique, which transfers knowledge from a large or complex model to a smaller or simpler model, such as using soft labels. The training of local machine learning models can be carried out without manual labeling of the training data, which enables massive scale training.

When new data is collected and stored at a client device, training process may be triggered and the machine learning models updated based on the new data. The output of the trained machine learning models in the FL architecture may be used to generate inventory recommendations and offer recommendations based on client shopping behaviors. Such recommendations may include user preferences such as, for example, brand and product preferences. As the machine learning models are trained and updated on a client device based on local data, the machine learning models are therefore configured to take user-specific (e.g., user of the client device) preferences into considerations when making inventory recommendations, which provides improved user experience, in addition to improved data privacy. For instance, the inventory recommendations may be generated based on a user's personalized lifestyle insights.

In addition to providing a high level of data privacy and data integrity, client consent from a user of the client device may be, in some embodiments, required prior to deployment and training of one or more machine learning models in a FL architecture.

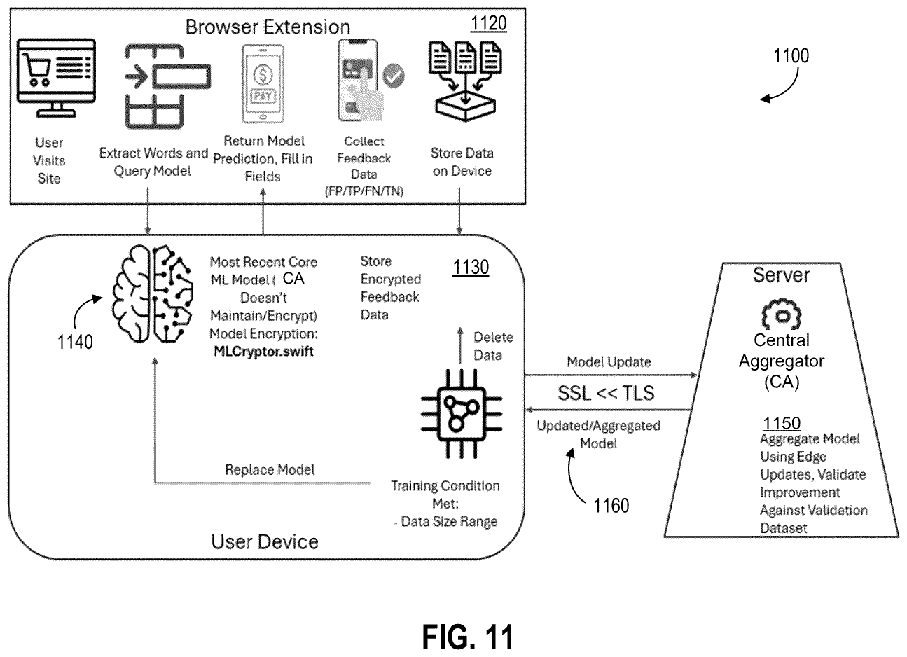

FIG. 11 shows a schematic diagram 1100 showing an example FL architecture with browser extension 1120. The browser extension 1120 may be, for example, a front-end browser extension that interoperates with an existing browser application on a user device 1130 to extract words and other information from a web page using a trained ML model 1140 stored on user device 1130.

The ML model 1140 may be encrypted, and at inference time, generates predictions based on the extracted words, such predictions may include page classification prediction, field classification prediction, and other text prediction in accordance with one or more autofill operations described above. In addition, a number of feedback data and user data may be collected during the web page browsing session and stored locally on user device 1130, the data may be encrypted. The local storage of user data is monitored for a condition, such as a size limit; when the size limit is met or exceeded, the user data may be used for further training or fine-tuning the machine learning model 1140. The machine learning model 1140, after said training or fine-tuning, has updated weights or parameters (“model update”), and the model update is then transmitted to a central aggregator (CA) 1150 using secured network connection SSL or TLS.

In some embodiments, training data is processed with signal for true positive (TP), false positive (FP), true negative (TN), and false negative (FN) and automatically labeled based on each respective signal. The training data may be purged after the local model 1140 has been trained with said training data. In addition, once a global model has been received from the CA 1150, the previous version of the ML model 1140 may be also purged.

The CA 1150 aggregates various model updates from different models including ML model 1140, and sends an updated or aggregated global model 1160 back to user device 1130, which replaces the previous version of the ML model 1140.

In some embodiments, one or more machine learning models stored on a local client or user device 1130, may be trained to provide a page classifier module (e.g., page classifier module 182) having a page classifier machine learning model trained at the client device, based on local data stored at the client device. A locally trained page classifier module may improve performance and scalability of page classification, and to improve accuracy of the machine learning models with respect to the specific user of the client device. Incremental user consent may be requested and stored in association with the training of the local machine learning models (such as the machine learning models in the page classifier module).

In some embodiments, one or more machine learning models stored on a local client or user device 1130, may be trained to provide a field classifier module (e.g., field classifier module 185) having a field classifier machine learning model, which may collect and store a user's browsing data from a previous or current shopping journey to make inventory recommendations. Such local deployment of machine learning models may mitigate model decay and maintains accuracy by adapting to merchant site changes. In some embodiments, the page classifier machine learning model may be locally trained using adversarial testing and galvanization.

In addition, more payment options may be detected and generated at a checkout stage using the locally trained page or field classifier module.

In some embodiments, one or more local machine learning models may be encrypted on the client device to provide additional data security.

Training and fine-tuning of local machine learning models using local user data may provide horizontal scaling across millions of client devices, and improved machine learning models that will learn from old and new web pages. During aggregation of the different machine learning models from various client devices, the local machine learning models stay confidential, along with the local data, and only model updates are transmitted to a central server for aggregation.

In some embodiments, a local machine learning model may be deployed as a local data model on the client device, which can be configured to collect relevant user data for inventory recommendation. An example local data model may be deployed to capture lifestyle data beyond traditional shopping, such lifestyle data may include, for example, user data representing behaviors related to purchase of a vehicle or house, travel planning, and so on. In some embodiments, local data may be collected via a Kafka queue.

Based on the collected user data by the local data model, one or more locally stored and trained machine learning models may, at inference time, generate hyper-personalized product or other types of inventory recommendations based on the lifestyle data. For instance, warranty registrations may be autofilled for a product recently purchased online, a client's preferred size or color may be pre-selected or autofilled for one or more products displayed on a web browser or a mobile application.

For example, the lifestyle data may include, during a web browsing session where the user is shopping for a golf club, data representing sports instrument currently or previously browsed by the user, data representing sports instrument previously purchased or placed in a shopping cart by the user, data representing web sites browsed by the user in a limited amount of time, and such lifestyle data may be analyzed and processed to generate on one or more offers, such as a personalized discount for the golf club the user wishes to purchase.

In some embodiments, in addition to specific products, the system may be implemented to make hyper-personalized services or products in advance (e.g., mortgage, car loan, line of credit) based on the user's intent as predicted by a ML model stored on the local user device.

In some embodiments, FL can be implemented confidentially on approved merchant websites or domains. One or more machine learning models deployed on local client devices may be compressed, which may have access to locally stored data and user profile. Large language models (LLMs) may be deployed as part of the ML models on local client devices to deliver intelligent inventory recommendations to the client device, and to translate speech or text into shopping orders without requiring a user to navigate from their current web page, which may be unrelated to the specific shopping order.

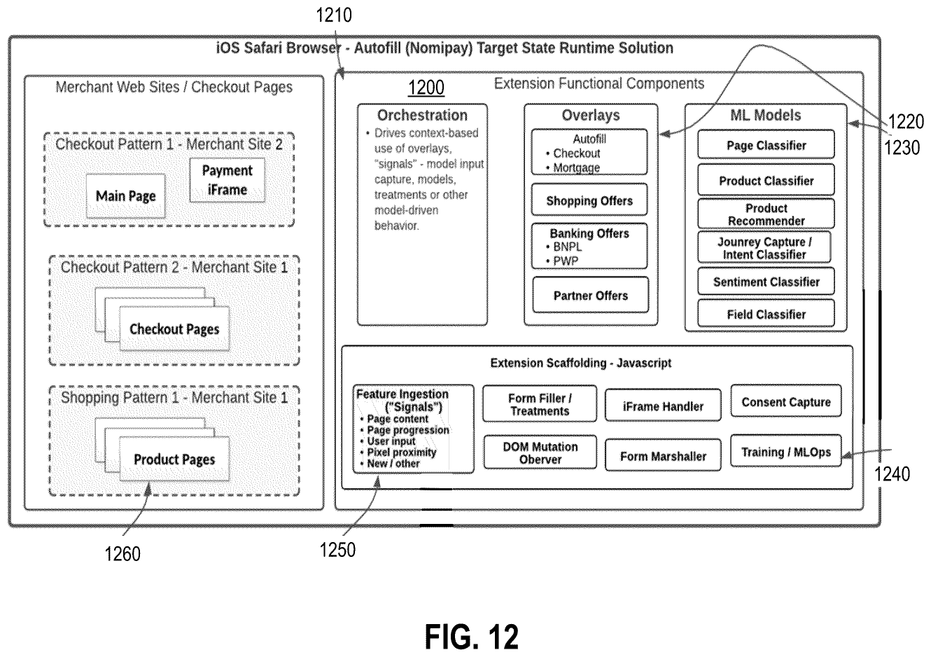

FIG. 12 shows an example embodiment of a browser with a browser extension 1200 having a number of ML models deployed. The extension 1200 includes a number of components such as an orchestration component 1210, overlays component 1220 and ML model component 1230, which includes a number of ML models. The orchestration component 1210 may be configured to drive context-based use of overlays and signals to perform model input capture, model updates, and so on.

The overlays component 1220 may provide a number of functions including autofill of one or more fields detected on a web page during a checkout process, or during a mortgage application process, as an example. The overlays component 1220 may also generate a number of inventory offers such as shopping offers, banking offers, and other partner offers.

The ML model component 1230 may include a number of ML models such as, for example, page classifier model, product classifier model, product recommender model, user shopping journey model with a user intention classifier, sentiment classifier model and/or field classifier model. The training of ML models in the ML model component 1230 may be implemented using JavaScript™, providing support for federated learning architecture, with dynamic and incremental model distribution.

User shopping journey may include shopping data and parameters including for example, pages visited, search terms, products browsed or added to chart, cart size, and so on.

The overlays component 1220, ML model component 1230 and feature ingestion (“signal”) component 1250 may be implemented as plugin models providing support for multiple applications. The signal component 1250 drives automation tasks such as autofill of one or more fields on a web page, and also supports activity logging or tracking.

The products page 1260 may be populated based on the output of one or more ML models in the ML model component 1230 at inference time. The products may include one or more inventory recommendations or offers, such as a product or a service offering.

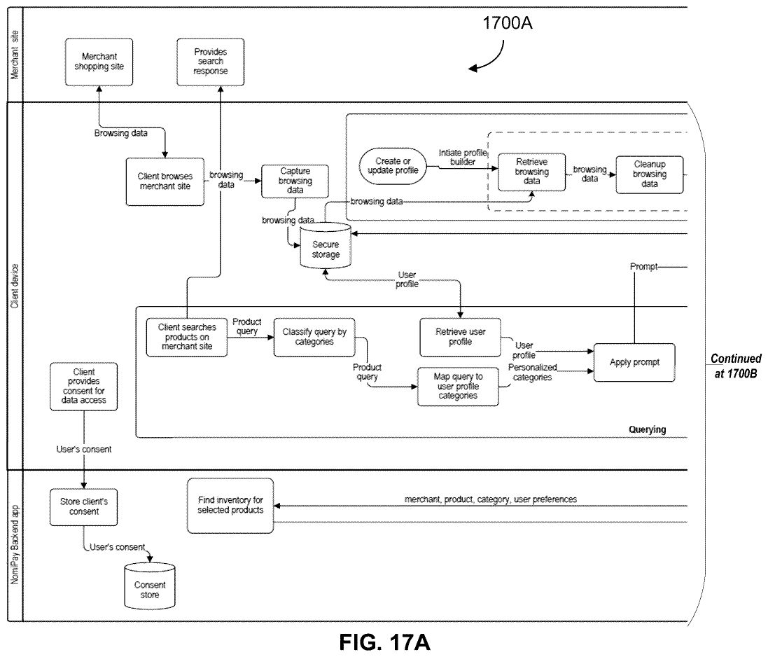

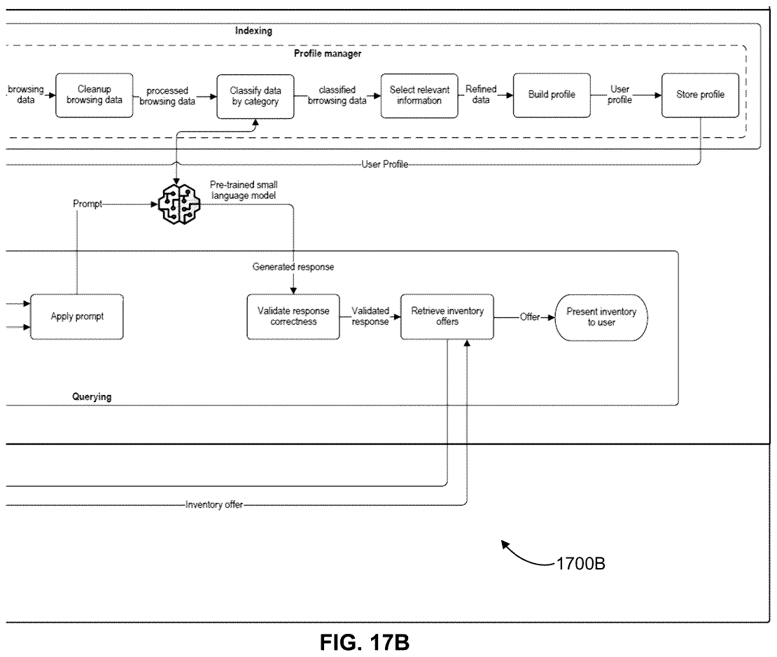

FIGS. 17A and 17B illustrate an example process 1700A, 1700B, performed by an embodiment of a system described herein, for building a user profile from local data and utilizing local ML models to generate customized or hyper-personalized inventory recommendations or other types of offers to a user, in accordance with some example embodiments.

In some embodiments, the system can be configured to: obtain (or retrieve stored) user consent, generate a prediction based on a user's browsing journey and other data (e.g., user profile) representing one or more predicted action(s), and cause the browser at the user device to generate a graphical user interface (GUI) element such as a pop-up window to facilitate user interaction. For instance, the GUI element be generated by an overlay component in the browser extension, and interrupt or prompt the user to accept or deny the predicted action(s), which may be, for example: adding an item the user is likely looking for with a suitable price to his or her shopping cart; finding the most cost-effective item the user is likely looking for to purchase on the web; and/or completing a purchase with proper delivery mechanism based on existing user information.

The user may be presented with a number of product or service offers, and may elect one product (e.g., a pair of new running shoes). The system may, using existing user data and execution of the trained local machine learning models stored on the device, generate data for autofill of a shopping cart and/or completing a payment of transaction, such as, for example: brand preferences, preferred color of the shoes, which may be obtained based on a previous purchase of a similar running shoes, shoe size, other general color preferences, preferred price range, and home address. In some embodiments, the system may be configured to execute the locally stored ML models to generate and present a list of k products, from which the user may select one or more for completion of a purchase, and the system may continue to finish the purchase transaction without the user having to navigate away from their current browsing session.

Example user data that may be collected and stored on the local user device for training and generation of predictive actions or products may include, as non-limiting example: credit or debit card transaction data, loan data, mortgage-related data, and lifestyle data including:
Browsing history:
   previous product searches,
   merchant products viewed,
   shopping cart content: quantity of products bought, total amounts etc.
Social media: Instagram, Facebook, X posts etc.
Professional: LinkedIn profile
Investment history extracted from tax forms
Medical profile
Food preferences
Charity
Education
Travel advice
Merchant shopping cart information

Throughout the entire process, the system is implemented to ensure user privacy, as user data is safeguarded (e.g. not transmitted outside of the user device) to ensure its privacy is preserved throughout the entire process. The system is also configured to provide generated insights, or recommended actions are tailored to fit within user's unique profile, in synchronization with his actions and personal preferences or habits. The system provides a seamless user browsing and shopping experience, by automating his shopping journey, from auto-filling his personal information to supporting product discovery and decision making.

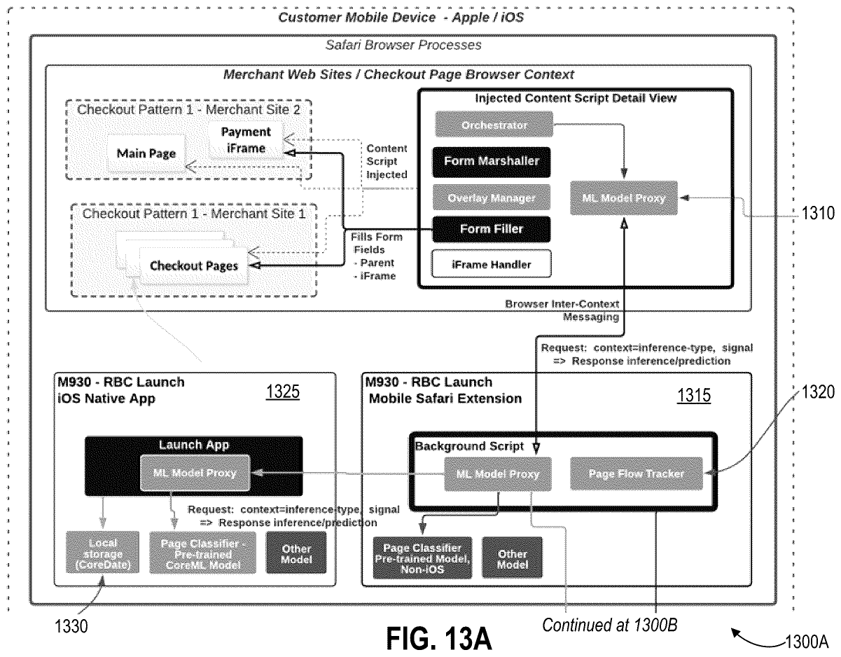

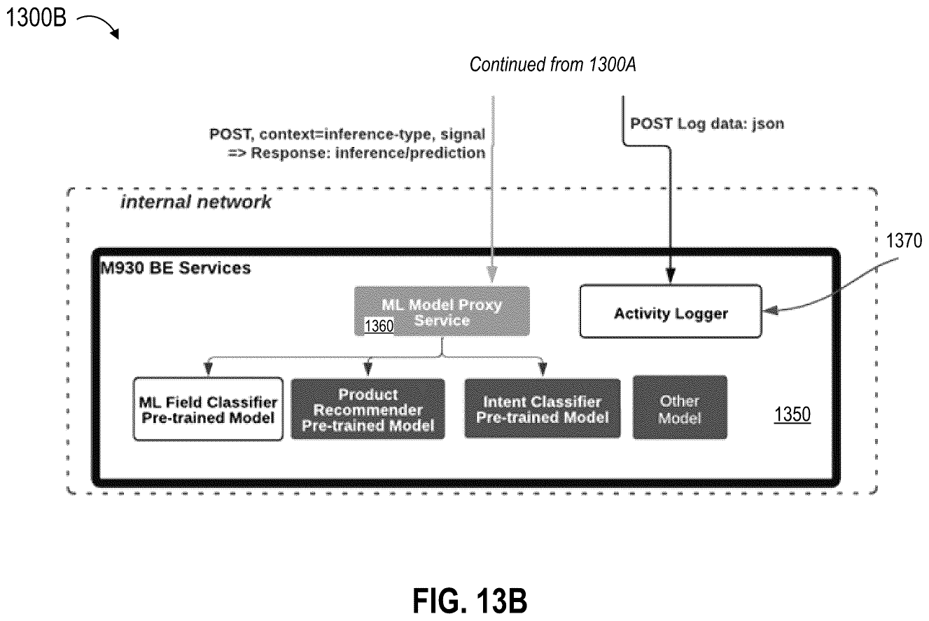

FIGS. 13A and 13B shows two parts 1300A, 1300B of an example schematic diagram illustrating a browser process in accordance with one example embodiment. The browser process occurs at a browser application on a user device. A ML model proxy interface 1310 establishes a location transparent, request/response format for ML model deployment and inference. Model training and distribution may vary by platform or location.

A page flow tracker 1320 as part of the extension 1315 is configured to track function that cannot be handled at the page level. An native application 1325 on the user device may include a secure storage element for caching activities and signals as input to local training of models in a FL architecture.

A server 1350 connected to the user device may have a central aggregator central aggregator 1360 (e.g., “ML model proxy service”) and an activity logger module 1370. The CA 1360 may receive model updates from one or more user devices and aggregate the model updates to generate one or more global ML models.

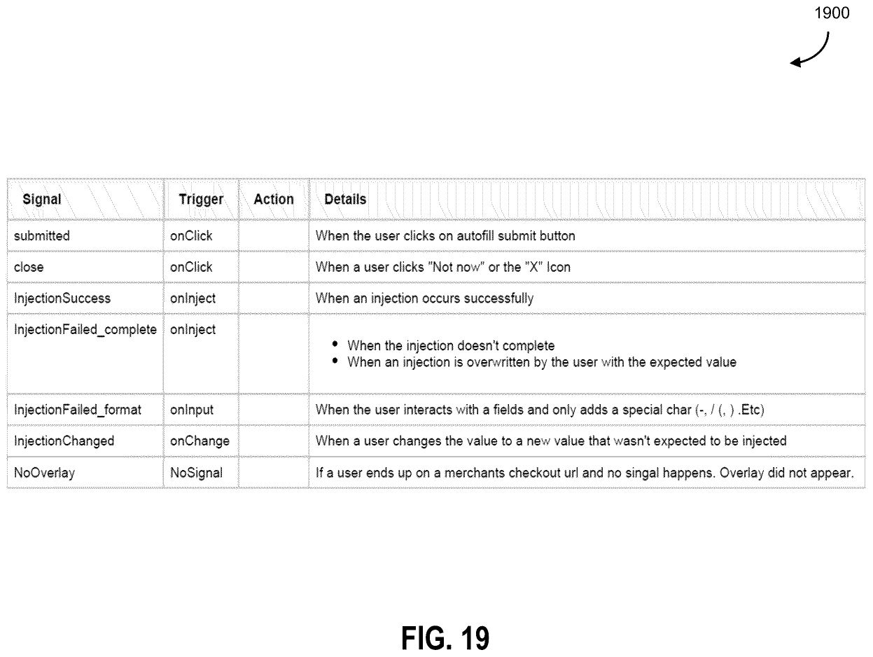

In some embodiments, on the server 1350, validation dataset which can be used to measure performance of the global updated model may be used to validate the global ML model before it is pushed to one or more user devices. In some embodiments, the global ML model at the CA 1360 may be tested against a validation set, and by collecting error signals from the various user devices. The error signals may be detected based on user actions, such as, for example, when a user changes what the autofilled field(s), or does not fill out any fields in a page that's classified as a payment page. FIG. 19 shows example signal processing of various user actions and triggers detected on a web page.

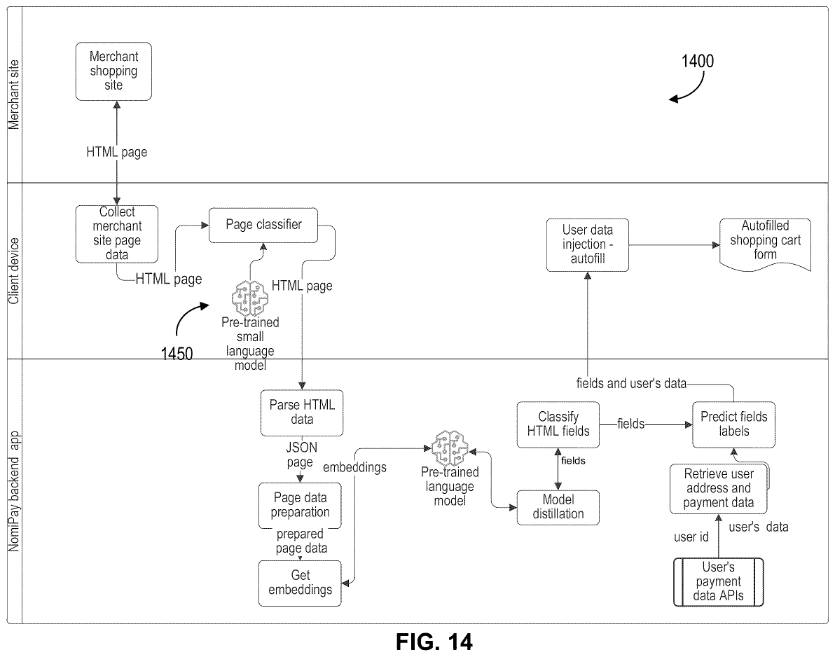

FIG. 14 illustrates an example flow chart 1400 illustrating a process of automating an user's browsing and shopping journey using FI-trained local machine learning models. In some embodiments, the ML model 1140 may include a large language model (LLM) 1450 used to analyze text and other information from the web browsing session. Automating the shopping experience focuses on auto-filling user's personal data (name, address, card information), for a faster and better customer experience. The LLM model 1450 can increase accuracy of the page and field classifier model predictions. For example, the LLM 1450 can be installed on the user's device, to determine the classification for each shopping page (address, payment, etc.) Multiple LLM models may be needed, for respective profile domains (fitness, investment, health, education, and so on).

FIGS. 15 and 16 illustrate an example flow chart 1500 illustrating a process of training and updating FI-trained local machine learning models. An example system may train and update local ML models for classifying merchant site pages or fields, by employing a federated learning (FL) workflows across multiple user devices. This approach can provide additional exposure to more merchants'data, enriching the single-user model to additional data sets. Example implementation of federated learning tools may include, for example, Flower for on-device, training support and (NVIDIA™) Flare for server-side, and confidential model aggregation can be implemented. The server-side model aggregator (FL) can be deployed using NVIDIA™ confidential computing infrastructure (e.g. NVIDIA™ H100), to protect the federated learning (FL) aggregation computations. Similar pattern can be applied to other machine learning models including for example: product recommender, offer recommender.

In some embodiments, example data processing of user data for training of one or more local machine learning models may include one or more steps of: obtaining or confirming user consent, retrieving available data sets, classifying data sets according to respective category, and relevance for personalization, de-identifying relevant data sets to remove user's personal identification information (PII), and aggregating the de-identified data sets.

In addition, a user profile may be generated or built with defined profile categories, such as: investment risk, browsing interest for travel, budget for renovation, fitness level, and so on.

Next, the system may be configured to extract categories values from the personal data, with the help of small language models deployed on user device to ensure the privacy of his personal, sensitive data. Additionally, employing cross-device federated learning (FL) tools, can identify similar users'preferences and recommend them to the current user. Examples of defined categories and respective extracted values may include investment-risk: low; browsing interest for travel: medium; budget for renovation: low; and fitness-level: high.

In some embodiments, a user may be prompted to submit one or more user input for generation of recommendations. Such user input may include answers to pre-defined questions, and such questions may be classified according to its underlying topic/domain: investment, travel etc., then the respective values for the question's category or topic can be extracted to form the category for the user profile.

In some embodiments, updated prompt and question are sent to small language model, to generate the specific response matching user profile and preferences.

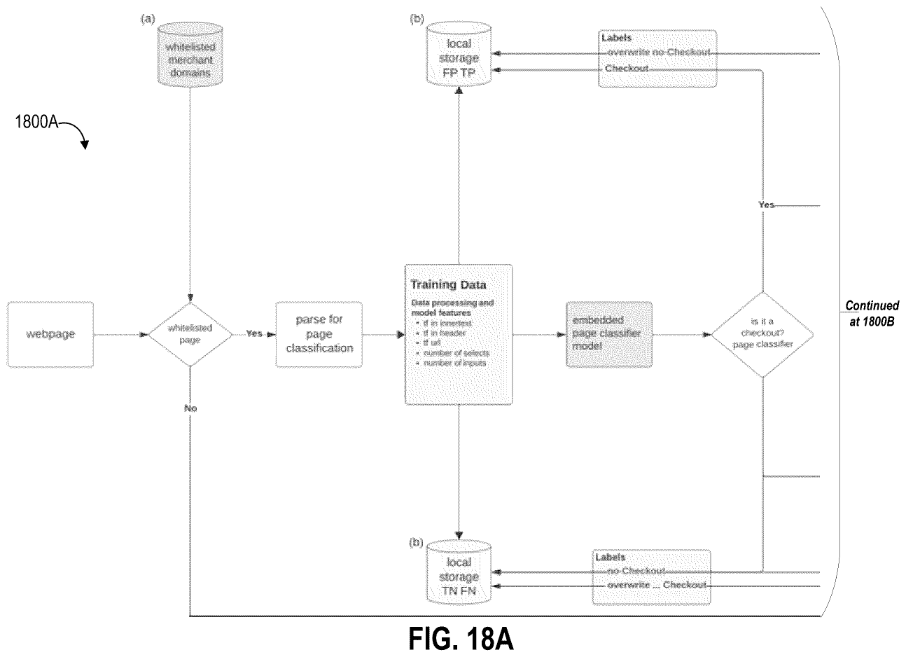

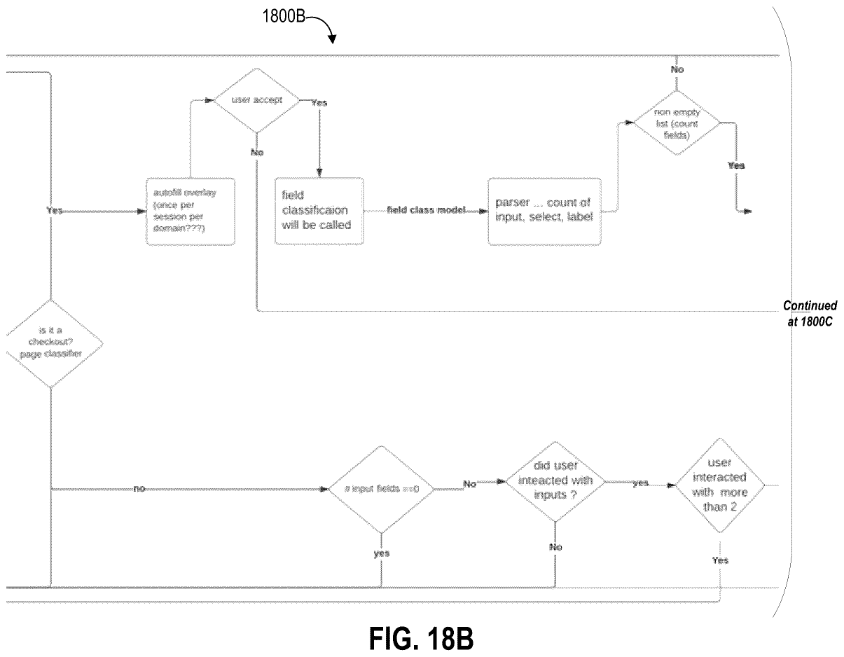

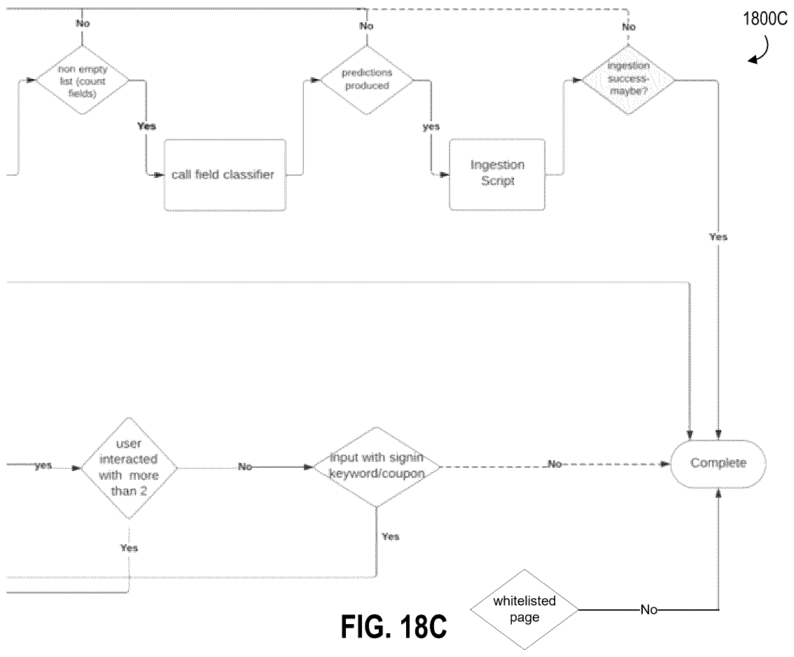

FIGS. 18A, 18B and 18C shows three parts 1800A, 1800B, 1800C of an example schematic diagram illustrating an automated signal and data collection process, in accordance with one example embodiment. The automated signal and data collection process may be used to generate labels for training data used to train a local page classifier model to automate the labelling. As illustrated, a web page is processed for data collection and signal processing, and training data is collected and stored in one or more local data storage devices. The web page is classified using a page classifier model, and different operations may be carried out depending on the result of the page classifier model. For instance, if the web page is determined by the page classifier model to be a checkout page, autofill overlay may be executed to call field classifier model and to perform autofill operations as described herein. Further, labeling of the training data occurs automatically based on various signals generated during this process.

In some embodiments, the global ML model at the central aggregator may be tested against a validation set, and by collecting error signals from the various user devices. The error signals may be detected based on user actions, such as, for example, when a user changes what the autofilled field(s), or does not fill out any fields in a page that is classified as a payment page. FIG. 19 shows example signal processing of various user actions and triggers detected on a web page.

In a practical implementation example, referring to FIG. 15, there can be a user device for operation of a browser extension adapted for machine-learning based field value injection into a browser session, the machine-learning based field value injection coordinated between local edge computing storage and a centralized federated machine learning model computing backend.

The user device includes a computer processor; and a memory device storing a first local machine learning model configured for page classification, a second local machine learning model configured for field classification, and a third local machine learning model configured to autofill text injection, the first local machine learning model and the second local machine learning model both trained using federated learning with the centralized federated machine learning model computing backend, and the third local machine learning model trained at least based on one or more datasets obtained through monitored user interaction with one or more interactive controls of the browser. The user device further includes storage media such as a non-transitory computer-readable media storing instructions that when executed by the computer processor.

The three local machine learning models operate in tandem—the page classifier is used to limit the number of pages that require the heavyweight computing cost of the field classification, and then the autofill/text generation of the third local machine learning model is only invoked after the field classification is conducted.

The user device operates the browser extension as a mobile application on the user device, and the browser extension can be a separate application process or can be a complementary application process that is configured to launch when the browser application is operating.

The user device monitors user interactions with the one or more interactive controls of the browser to generate interaction training sets. Example interaction training sets include the user's browser history, input terms, input/touchscreen interactions, among others. These can be stored in local memory of the user device such that these data sets are not released to any third party devices to safeguard the user's privacy.

These interactions are used to periodically train the third local machine learning model. By periodically training the third local machine learning model, the outputs of the third local machine learning model can be tailored for the preferences of the specific user. In some embodiments, the third local machine learning model is also updated using model updates received from a centralized federated learning backend, which can be operated, for example, by a financial institution who also has a tracked user profile of the user. While the first and second local machine learning models are classification models, the third local machine learning model can be an adapted version of a foundational large language model that is being fine-tuned through the updates and the local training to reflect the preferences of the user.

The updating of the third local machine learning model can be controlled based on privacy controls and settings controlled by the user, so only certain interactions will be used for training, and not others. In some embodiments, training can also be controlled through a training button that toggles whether training is active or not (e.g., not active in an incognito session). The reason why the training is important is that the training of the third local machine learning model allows it to determine additional details about the user's purchasing journey and preferences, such as budget, whether the user has decided on a particular purchasing decision or is still researching, and whether the user is interested in other related goods, or potential financing options.

When the browser extension determines that a webpage is being traversed by the browser (e.g., through the browser actively requesting webpages and a watcher process daemon tracking the traversal and rendering of these pages as HTML pages being served to the user on the user's display), the browser extension first operates the first local machine learning model for page classification to generate a classification output indicative of whether the webpage is a checkout process related webpage. In some embodiments, all pages that are not checkout process related are ignored to reduce the overall demand on computing resources as mobile computing resources can be very limited. Example outputs of the first local machine learning model can include normalized classification logits, such as webpage_class_checkout=0.7, which is greater than a threshold of 0.6, so a page is classified as a checkout page.

When a checkout page is being encountered, then the second machine learning model will be operated to classify various fields identified in the page. This is conducted through a scraping or download of the rendering code of the webpage, and parsing rendering code of the webpage to identify one or more fillable field data objects in the webpage. The one or more fillable field data objects can be identified in specific code blocks or DOM tree structures, and can be associated with specific HTML tags, for example. The one or more fillable field data objects can be identified through interactions through HTML GET POST directives, for example.

The second local machine learning model requires more computational resources than the first due to the larger set of features being processed, and it operates sparingly only when checkout pages are encountered. For each field, classification label metadata is assigned based on the classification output of the second local machine learning model.

Effectively, a classification prediction is used to identify if a field is “address”, “name”, or more complex fields, as described further below, such as “potential eligibility for discounts”, “interested in any other related products?”, “could this user benefit from and/or qualify for a particular promotion or financial product to aid with the purchase?”. Not all fields are visible—some fields may be invisible to the user, and identified through anchors or other types of code artifacts deliberately included to trigger a particular classification.

The third local machine learning model is operated to generate text autofill input strings that are recommended (or in some embodiments, for the hidden fields auto-injected) for entry into the various fields. For example, these can include customized delivery instructions “please deliver during a time window of 3-5 PM on Friday and leave on doorstep only without interaction”, or additional instructions such as “this is a gift for my wife, so please include a gift receipt and select the optional happy birthday card”.

The third local machine learning model is computationally expensive to operate, so the first local machine learning model operates to limit the operation until only checkout pages are identified.

In further variant approaches, the centralized federated machine learning model computing backend can be configured to periodically update the first and second machine learning models, and potentially the third local machine learning models by sending parameter update datasets. These can include instruction sets for adjusting parameter weightings as well as supervised learning tuples, and the reason for this update is that the corpus of users will encounter different types of webpages and fields, and misclassifications can be used to update the models for the benefit of all user devices. The updates can be periodically pushed out, for example, along with browser extension application updates. The user device is configured to periodically submit an embeddings data object based on the interaction training sets and feedback data to the centralized federated machine learning model computing backend, and the centralized federated machine learning model computing backend is configured to generate the parameter update datasets received from a plurality of user devices. To help preserve privacy, the centralized federated machine learning model computing backend can be configured to discard the embeddings data object following generation of the parameter update datasets.

As noted above, certain webpages can be designed for specific interaction with the browser extension, and this is an innovative usage of the autofill capability to automatically initiate a two-way interaction with the browser extension. For example, the webpage may be designed with the browser extension capabilities in mind, setting triggers for offering different types of bundle deals or checking eligibility for additional deals, promotions, campaigns, or financial products automatically by deliberately triggering and interrogating the browser extension autofill outputs.

Upon the webpage backend server receiving a field response from the browser extension indicative that the user qualifies for a particular product or campaign, the webpage backend server can dynamically serve up an updated interface element, advertisement, or offer, that has a very high relevance to the user. In some embodiments, the browser extension and the webpage server cooperate using the two-way interaction to generate very customized offers based on the user's journey as tracked in the third machine learning model outputs.

The two-way interaction responses can be configured to require explicit approval by the user before any responses are sent back, in some embodiments. In other embodiments, the user provides a blanket approval and the extension automatically attempts to negotiate with the webpage backend server using the autofill feature, sending messages back and forth in an attempt to trigger a greater amount of discounts or benefits for the user.

An example two-way interaction can include the webpage including a hidden field with the prompt for a free text input: “Is this user interested in any more back to school items?”. The browser extension can autofill this free text input field with “Yes, the user has been browsing stationery supplies and just started the purchasing journey”. The webpage can then dynamically serve up a bundle deal that is an in-line offer that is unique to that user to assist the user in their purchasing journey. This represents a win-win situation for the merchant, as the merchant already has the user in a checkout flow and does not have to expend any ad-cost to attract the user, and for the user, a specialized bundle deal may provide increased savings at no cost to the user. More sophisticated flows can include further two-way automated interactions between the browser extension and the webpage (e.g., the PHP server operating the webpage). Another example use case includes determining whether the user would be interested in or a good candidate for a financial promotion during the checkout process, such as a buy now pay later, an in-line loan, or a mortgage loan, depending on the transaction. If the autofill input indicates that the user is not likely to be interested, the promotion can simply not be shown. On the other hand, if it does indicate and meets the webpage's criteria, the webpage can be controlled by the web server to inject in corresponding visual elements, fields, or additional pages corresponding to an additional flow for offering the product.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects.

Although the embodiments have been described in detail, it should be understood that various changes, substitutions and alterations can be made herein without departing from the scope as defined by the described embodiments. Moreover, the scope of the present application is not intended to be limited to the particular embodiments of the process, machine, manufacture, composition of matter, means, methods and steps described in the specification.

As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

I claim/we claim:

1. A user device for operation of a browser extension adapted for machine-learning based field value injection into a browser session, the machine-learning based field value injection coordinated between local edge computing storage and a centralized federated machine learning model computing backend, the user device comprising:
a computer processor;
a memory device storing a first local machine learning model configured for page classification, a second local machine learning model configured for field classification, and a third local machine learning model configured to autofill text injection, the first local machine learning model and the second local machine learning model both trained using federated learning with the centralized federated machine learning model computing backend, and the third local machine learning model trained at least based on one or more datasets obtained through monitored user interaction with one or more interactive controls of the browser;
a non-transitory computer-readable media storing instructions that when executed by the computer processor, cause the computer processor to:
monitor the user interaction with the one or more interactive controls of the browser to generate interaction training sets;
periodically train the third local machine learning model using the generated interaction training sets;
upon the browser extension determining that a webpage is being traversed by the browser, operate the first local machine learning model for page classification to generate a classification output indicative of whether the webpage is a checkout process related webpage;
parse rendering code of the webpage to identify one or more fillable field data objects in the webpage;
upon the classification output indicative of whether the webpage is the checkout process related webpage being greater than a pre-defined threshold; operate the second local machine learning model for page classification to generate one or more field classification outputs indicative of estimated classifications of a type of each of the one or more fillable field data objects of the webpage;
assign classification label metadata for each of the one or more fillable field data objects of the webpage based on the classification output of the second local machine learning model; and
for each field of the webpage; operate the third local machine learning model in an inference mode using at least the classification label metadata to generate text autofill input strings assigned to each of the one or more fillable field data objects of the webpage.

2. The user device of claim 1, wherein the computer processor is configured to periodically receive parameter update datasets from the centralized federated machine learning model computing backend, and update the first local machine learning model configured for the page classification, the second local machine learning model configured for the field classification based at least on the parameter update datasets.

3. The user device of claim 2, wherein the computer processor is configured to periodically submit an embeddings data object based on the interaction training sets to the centralized federated machine learning model computing backend, and the centralized federated machine learning model computing backend is configured to generate the parameter update datasets received from a plurality of user devices.

4. The user device of claim 3, wherein the centralized federated machine learning model computing backend is configured to discard the embeddings data object following generation of the parameter update datasets.

5. The user device of claim 1, wherein the webpage includes one or more autofill anchor code objects in the rendering code of the webpage that are adapted to trigger field classification indicative of a two-way interaction request with the browser extension, the two-way interaction request triggering an exchange of data messages between the browser extension and the webpage using one or more generated text autofill input strings.

6. The user device of claim 5, wherein the one or more autofill anchor code objects are code objects embedded in a DOM tree structure of the rendering code.

7. The user device of claim 5, wherein the exchange of data messages between the browser extension and the webpage using the one or more generated text autofill input strings triggers one or more dynamic webpage code objects being rendered by a webserver hosting the webpage.

8. The user device of claim 7, wherein the third local machine learning model is configured to update periodically based on parameter update datasets from the centralized federated machine learning model computing backend.

9. The user device of claim 8, wherein training of the third local machine learning model based on the generated interaction training sets is constrained based on one or more privacy setting values stored on the user device.

10. The user device of claim 9, wherein the user device is a smartphone device associated with the user, the smartphone device storing the first local machine learning model configured for page classification, the second local machine learning model configured for field classification, and the third local machine learning model configured to autofill text injection in a secure enclave memory region of the smartphone device, and the browser extension is a mobile application process executable by the computer processor to operate while the browser is being operated.

11. A method for operation of a browser extension adapted for machine-learning based field value injection into a browser session, the machine-learning based field value injection coordinated between local edge computing storage and a centralized federated machine learning model computing backend, the method comprising:
maintaining a first local machine learning model configured for page classification, a second local machine learning model configured for field classification, and a third local machine learning model configured to autofill text injection, the first local machine learning model and the second local machine learning model both trained using federated learning with the centralized federated machine learning model computing backend, and the third local machine learning model trained at least based on one or more datasets obtained through monitored user interaction with one or more interactive controls of the browser;
monitoring the user interaction with the one or more interactive controls of the browser to generate interaction training sets;
periodically training the third local machine learning model using the generated interaction training sets;
upon the browser extension determining that a webpage is being traversed by the browser, operating the first local machine learning model for page classification to generate a classification output indicative of whether the webpage is a checkout process related webpage;
parsing rendering code of the webpage to identify one or more fillable field data objects in the webpage;
upon the classification output indicative of whether the webpage is the checkout process related webpage being greater than a pre-defined threshold; operating the second local machine learning model for page classification to generate one or more field classification outputs indicative of estimated classifications of a type of each of the one or more fillable field data objects of the webpage;
assigning classification label metadata for each of the one or more fillable field data objects of the webpage based on the classification output of the second local machine learning model; and
for each field of the webpage; operating the third local machine learning model in an inference mode using at least the classification label metadata to generate text autofill input strings assigned to each of the one or more fillable field data objects of the webpage.

12. The method of claim 11, comprising periodically receiving parameter update datasets from the centralized federated machine learning model computing backend, and updating the first local machine learning model configured for the page classification, the second local machine learning model configured for the field classification based at least on the parameter update datasets.

13. The method of claim 12, comprising periodically submitting an embeddings data object based on the interaction training sets to the centralized federated machine learning model computing backend, and the centralized federated machine learning model computing backend is configured to generate the parameter update datasets received from a plurality of user devices.

14. The method of claim 13, wherein the centralized federated machine learning model computing backend is configured to discard the embeddings data object following generation of the parameter update datasets.

15. The method of claim 11, wherein the webpage includes one or more autofill anchor code objects in the rendering code of the webpage that are adapted to trigger field classification indicative of a two-way interaction request with the browser extension, the two-way interaction request triggering an exchange of data messages between the browser extension and the webpage using one or more generated text autofill input strings.

16. The method of claim 15, wherein the one or more autofill anchor code objects are code objects embedded in a DOM tree structure of the rendering code.

17. The method of claim 15, wherein the exchange of data messages between the browser extension and the webpage using the one or more generated text autofill input strings triggers one or more dynamic webpage code objects being rendered by a webserver hosting the webpage.

18. The method of claim 17, wherein the third local machine learning model is configured to update periodically based on parameter update datasets from the centralized federated machine learning model computing backend.

19. The method of claim 18, wherein training of the third local machine learning model based on the generated interaction training sets is constrained based on one or more privacy setting values stored on the user device.

20. A non-transitory computer readable medium storing machine interpretable instructions, which when executed by a computer processor, cause the computer processor to perform a method for operation of a browser extension adapted for machine-learning based field value injection into a browser session, the machine-learning based field value injection coordinated between local edge computing storage and a centralized federated machine learning model computing backend, the method comprising:
maintaining a first local machine learning model configured for page classification, a second local machine learning model configured for field classification, and a third local machine learning model configured to autofill text injection, the first local machine learning model and the second local machine learning model both trained using federated learning with the centralized federated machine learning model computing backend, and the third local machine learning model trained at least based on one or more datasets obtained through monitored user interaction with one or more interactive controls of the browser;
monitoring the user interaction with the one or more interactive controls of the browser to generate interaction training sets;
periodically training the third local machine learning model using the generated interaction training sets;
upon the browser extension determining that a webpage is being traversed by the browser, operating the first local machine learning model for page classification to generate a classification output indicative of whether the webpage is a checkout process related webpage;
parsing rendering code of the webpage to identify one or more fillable field data objects in the webpage;
upon the classification output indicative of whether the webpage is the checkout process related webpage being greater than a pre-defined threshold;
operating the second local machine learning model for page classification to generate one or more field classification outputs indicative of estimated classifications of a type of each of the one or more fillable field data objects of the webpage;
assigning classification label metadata for each of the one or more fillable field data objects of the webpage based on the classification output of the second local machine learning model; and
for each field of the webpage; operating the third local machine learning model in an inference mode using at least the classification label metadata to generate text autofill input strings assigned to each of the one or more fillable field data objects of the webpage.
